(19) United States
(12) Patent Application Publication
(10) Pub. No.: US 2007/0120438 A1
(43) Pub. Date: May 31, 2007

(54) Electrostatic control device

(75) Inventor: Claire Divoux, Grenoble (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris 15eme (FR)

(21) Appl. No.: 10/584,202

(22) PCT Filed: Nov. 18, 2004
(86) PCT No.: PCT/FR04/50601

§ 371 Date: Jun. 23, 2006

(30) Foreign Application Priority Data
Dec. 26, 2003 (FR) 0351210

(51) Int. Cl. H02N 1/00

(52) U.S. Cl. 310/309

(57) ABSTRACT

An electrostatic actuation device including one mobile electrode, including at least one mobile part with respect to a substrate, at least two electrodes fixed with respect of the substrate, located on a same side of the mobile electrode and each facing a part of the mobile electrode, and at least one pivot with at least of portion of the mobile electrode.

### TECHNICAL DOMAIN

The invention relates to an electrostatic actuation device with an improved mechanical performance.

“Zipping” type actuation is a particular electrostatic actuation in which a mobile electrode comes into contact with or is pressed into contact with an insulator separating it from a fixed electrode, this movement being done progressively and practically linearly with the applied voltage.

Documents 1 and 2, referenced at the end of this description, describe a simple zipping with a return mechanism, while documents 3 and 4 describe a double zipping.

In known devices, the electrostatic force is a force that only acts in one direction, in attraction between two electrodes. Zipping generates greater forces but it maintains this special feature.

This type of actuation can be achieved in a plane, provided that there is room for fixed electrodes to be placed on each side of the mobile electrode. However, it is sometime desirable to have electrodes only on one side of the mobile part, for example for overall size reasons.

However, for a displacement of the mobile electrode outside the plane, while it is particularly simple to integrate the first fixed electrode into a substrate (for example using the substrate itself as the fixed electrode), it is particularly complicated to make a second fixed electrode above the mobile electrode. This second electrode is a source of technological complexity, and in particular it generates optical or electrical losses.

Therefore, in general only electrodes fixed onto the substrate are used, and a different nature of opposite force is used, often purely mechanical (return force) as described in documents 1 or 2, either by using additional return arms, or using the return force of the zipping arms themselves.

Since the nature of the two forces is then different, they are many parameters to be controlled. Forces are more difficult to balance because they are not necessarily equal, and they do not depend on the same equations. Simulation is also more difficult to implement due to the large number of parameters and physical phenomena to be taken into account. Furthermore, the technology is more difficult to produce because the two forces require different materials or different geometries. For example, return arms are often thinner or their thicknesses are not the same as in zipping structures, and control of actuators is also more difficult.

Therefore, a common design has been an electrostatic actuation in a single direction, with return arms for the other direction.

Only one solution is available for displacement in the two opposite directions by zipping, and this is described in document 4. Displacement of an incompressible fluid between two cavities can deflect a membrane. This solution is expensive and the displacement is difficult to control.

Therefore the problem arises of finding a new type of electrostatic actuator that enables the use of zipping in two opposite directions.

### PRESENTATION OF THE INVENTION

The invention relates to a zipping type actuation in two opposite directions.

The invention relates to an electrostatic actuation device comprising:
a so-called mobile electrode comprising at least one part free to move with respect to a substrate,
at least two electrodes fixed with respect to the substrate, located on the same side as the mobile electrode and each facing a part or an end of the mobile electrode,
means forming at least one pivot of at least one portion of the mobile electrode.

Thus, the two parts of an actuator can be controlled on each side of the pivot, with two zipping type forces of the same nature, and each of these two parts or a portion of each of these two parts can be brought into contact with the substrate or with a layer fixed with respect to the substrate, progressively as a function of the voltage.

The mobile electrode may bear on the pivot when one of the fixed electrodes attracts the part of the mobile electrode in front of which this fixed electrode is located, the other part of the mobile electrode possibly moving away from the substrate under the effect of mechanical return forces.

According to one variant, another purpose of the invention is an electrostatic actuation device comprising:
a part or membrane called the mobile or flexible part or membrane free to move with respect to a substrate, this part comprising at least two electrodes separated by an electrically insulating portion,
at least one electrode fixed with respect to the substrate, located on the same side of the mobile part and for which first and second parts are located facing one of the corresponding electrodes of the mobile part,
means forming at least one pivot of at least one portion of the mobile or flexible part or membrane.

The flexible part or membrane may bear on the pivot when one of the fixed electrodes attracts one of the electrodes of the mobile or flexible part or membrane, the other mobile electrode being free to move away from the substrate under the effect of mechanical return forces.

The electrode or the mobile part may be free to move along a direction approximately perpendicular to the substrate or a main plane of this substrate.

An insulating layer located on the substrate or on the mobile membrane can be used to separate the fixed electrodes and the mobile electrode or part.

The part or mobile membrane or the mobile electrode may be connected by a pad to a membrane located above the actuator or on the other side of the actuator from the substrate.

The pivot is used to keep at least one point of the electrode or the membrane or the mobile part at a distance of for example between 50 nm and 20 μm from the substrate. For example, it comprises at least one pad fixed with respect to the substrate, or according to another example, at least one arm placed on one side of the mobile part of the mobile electrode or the mobile membrane. Advantageously, it comprises two arms located on each side, the system then being symmetrical.

A load may be placed on the mobile or flexible membrane, laterally offset from the means forming the pivot. This load may thus have an amplitude greater than the height of the means forming the pivot. The amplitude of a point on the membrane laterally offset from the means forming the pivot is greater than the height of these means. For example, the means forming the pivot are arranged asymmetrically between two fixed electrodes or non-centred with respect between these fixed electrodes, and the amplitude of a point on the central part of the flexible electrode or membrane is greater than the amplitude of the means forming the pivot.

The mobile part of the mobile electrode or membrane may form an elbow, which enables a large movement.

A non-linear movement of a load located on the mobile part may be compensated by a structure comprising four fixed electrodes arranged in pairs facing each other, the mobile electrode or membrane comprising two mobile parts arranged crosswise.

The ends of the mobile electrode or membrane may be free or may comprise at least one fixed or embedded part, that may be fixed onto or into the substrate or an insulating layer. In one example, magnetic means fixed with respect to the substrate cooperate with magnetic means of the mobile electrode or membrane to maintain the ends of the electrode or the membrane in a fixed position with respect to the substrate.

According to one embodiment, the mobile electrode or membrane comprises at least two mobile parts, for example parallel to each other, each being free at one of its ends, a fixed electrode facing each mobile part. The free end of each mobile part has good flexibility, greater than the flexibility of a point located between the ends of the mobile electrode or membrane if these ends were fixed. These free ends make it possible to come into contact above the fixed electrode using low voltages.

For example, the mobile electrode or membrane comprises three mobile parts and there are three fixed electrodes, each located facing a part of the mobile electrode.

The mobile parts of the mobile electrode or membrane may be approximately elongated along one direction, at least two fixed electrodes being offset from each other in this direction. Depending on the variants, the mobile parts may be positioned at an acute angle or with lateral offsets, which provides mechanical stability in the plane of the substrate.

An element of electrical contact may be fixed on the mobile part to make a contactor. This is used to create a contact between two tracks or conducting areas in a given position of the mobile electrode or membrane. A variable capacitor may also be formed by a fixed armature and a mobile armature, for which the distance from the mobile armature is defined by the voltages applied to the actuator.

According to one variant, the mobile electrode or membrane, the fixed electrodes and the pivot are made approximately in a plane on the surface of the substrate.

Furthermore, the mobile electrode or membrane may comprise magnetic elements or means, or may be partially magnetic itself and may cooperate with magnetic elements or means fixed with respect to the substrate. This assembly of magnetic elements makes the system stable. At least two stable positions can be made in this way.

Preferably, the relative difference between the electrostatic force and the magnetic forces involved during a contact is at least 10%.

Mechanical return forces are preferably less than or very much less than the electrostatic force and the magnetic forces involved during a contact, for example at least 10 times less.

An actuation device according to the invention is useful for various applications, and particularly actuation systems with means forming a support for an optical component or an optical component itself.

The invention also relates to a process for making a device according to the invention, comprising:
production of a first substrate comprising one or two fixed electrodes with respect to the substrate,
production of means forming a pivot and a mobile electrode or membrane, comprising at least two electrodes separated by an insulating portion, this electrode or this membrane being free to move with respect to the substrate.

The mobile electrode or membrane may be made on a sacrificial layer formed or deposited on the substrate, then eliminated after formation of the membrane or the mobile electrode.

It may also be made on the surface of a second substrate subsequently assembled with the first substrate.

The mobile electrode or membrane is then removed from the surface of the second substrate by thinning the second substrate.

For example, the means forming the pivot are formed on the first substrate.

### BRIEF DESCRIPTION OF THE DRAWINGS

FIGS. 1A to 2B show variants of a first embodiment of the invention,

FIG. 3 shows another embodiment of the invention with a membrane connected to the contactors,

FIGS. 4A-4B show two other embodiments of the invention, the ends of the mobile electrode being embedded or held in place by magnetic means,

FIG. 5 shows an embodiment in the plane or on the surface of a substrate,

FIGS. 6 and 7 show two other embodiments of the invention, with actuator forming an elbow or a cross,

FIGS. 8A-8E show variants of an actuator with three mobile parts,

FIGS. 9A-11C are examples of actuators with electrical contact and/or magnetic means,

FIGS. 12A-12B are manufacturing steps of a device according to the invention,

FIGS. 13A-14B explain variants of devices according to the invention,

FIGS. 15A-15B show another type of device according to the invention that can be used as a micro-mirror or micro-lens,

FIGS. 16A-17B show variants of a device according to the invention that can be used as a micro-mirror or micro-lens,

FIGS. 18A-18L are manufacturing steps of a device according to the invention,

FIG. 19 shows another embodiment of a device according to the invention,

FIGS. 20A-20G show manufacturing steps of another type of a device according to the invention,

FIGS. 21A-21E show other manufacturing steps of another type of a device according to the invention,

FIGS. 22A-22C diagrammatically show operation of a device according to the invention,

FIGS. 23 and 24 show other aspects of a device according to the invention.

### DETAILED PRESENTATION OF PARTICULAR EMBODIMENTS

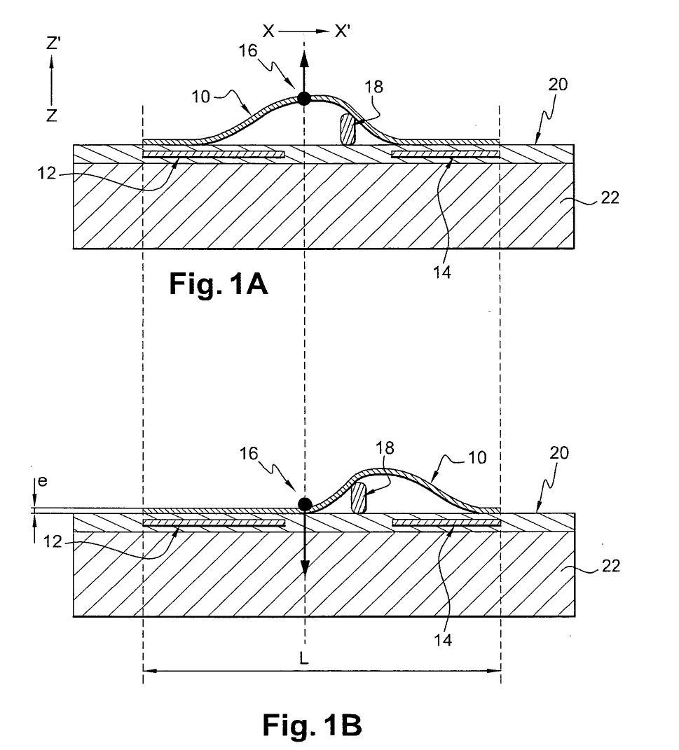

FIG. 1A shows an example of a device according to the invention.

A fixed electrode 12, 14 is located facing each end of a mobile or flexible structure or electrode 10, or a mobile or flexible membrane, one point of which is supported on a stop or a pad or a pivot 18, in a laterally offset position (along the XX′ direction) with respect to the position 16 of a load, for example a mechanical load or a mechanical or electrical contact or an electrical or optical component.

This assembly is also called an actuator.

The mobile structure 10 is insulated from the fixed electrodes 12, 14 by one or more insulating layers 20. These layers are located on the fixed structure as illustrated in FIG. 1A, but they may also be located on the mobile structure, which for example comprises a dual layer comprising an insulating layer and an electrode layer. The assembly consisting of the fixed electrodes and possibly the insulating layer(s) is supported on a substrate 22.

The pivot 18 maintains a point of the mobile electrode at a minimum height and possibly fixed height from the substrate 22. This height is measured along the ZZ′ axis perpendicular to the plane of the insulating layer 20. According to one example, the height of the pivot is for example between a few tens of nanometers, for example 50 nm, and 10 μm or 20 μm. Its height may be of the order of a few μm.

The length L of the membrane 10 may be of the order of a few hundred μm or may for example be between 50 μm and 1 mm. Its width measured along a direction perpendicular to the plane of FIG. 1A or 1B is of the order of a few μm or a few tens of μm, for example between 5 μm and 50 μm. The thickness e of the membrane may between 500 nm and 5 μm, for example equal to about 1 μm. All these values are given for guidance and devices according to the invention can be made with numeric values outside the ranges mentioned above.

The mechanical stiffness of the membrane is such that it can be brought into the high position under the effect of mechanical forces when the voltage is released (see FIG. 1A).

A potential difference is applied between the mobile electrode 10 and each fixed electrode 12, 14. This potential difference generates an electrostatic force in attraction or in repulsion between the two electrodes in each pair of electrodes (mobile electrode, fixed electrode). This force is easily controllable with the potential difference. Means of controlling this potential difference are provided but are not shown in the Figure. The membrane and the pad may be made of a conducting or semiconducting material or may comprise elements made from such materials, so that a voltage can be applied to the membrane through the pad 18.

If the potential difference (ddp) between the fixed electrode 12 and the mobile electrode 10 is decreased, and if the ddp between the fixed electrode 14 and the mobile electrode 10 is increased, the mobile structure progressively tilts towards the fixed electrode 14 and the load 16 moves upwards along the ZZ′ axis (FIG. 1A).

If the ddp between the fixed electrode 12 and the mobile electrode 10 is increased, and if the ddp between the fixed electrode 14 and the mobile electrode 10 is decreased, the mobile structure gradually tilts towards the fixed electrode 12, and the load 16 moves downwards along the ZZ′ axis (FIG. 1B).

Thus, the pivot forms a bearing point for the mobile structure when it is attracted by one of the fixed electrodes 12, 14: in fact, the central or mobile part of the membrane moves upwards and downwards under the combined effect of electrostatic and mechanical forces, therefore of different natures. The amplitude of the movement of this part is greater than the height of the pivot 18.

In one actuation device according to the invention, each of the fixed electrodes progressively forces part of the mobile electrode facing it into contact with the substrate as a function of the applied voltage.

The mobile electrode, part of which is pressed into contact with the substrate, then bears on the pivot, the other part of the mobile electrode for which the applied voltage is released being separated from the substrate under the effect of mechanical return forces.

This combined action of firstly electrostatic forces and secondly mechanical return forces result in a large amplitude greater than the height of the pivot.

In the above description, the pivot is a pad. However, other means could be used to make the pivot; for example mechanical arms on each side of the point at which the load is placed, which is advantageous to limit the lateral movement of this point (perpendicular to the plane in FIGS. 1A and 1B). A design with a single lateral arm is possible but is less stable than the above. Once again, the choice of materials from which the arm(s) is (are) made is used to apply a voltage to the membrane through the arm(s).

The pivot 18 may be made in the mobile part or in the fixed parts. It may be placed below or in the plane of the mobile part 10.

The fluid between the mobile electrode and the fixed electrodes may be air or another fluid, more or less viscous. Its permeability is preferably as large as possible, with good resistance to the electrical field and to aging.

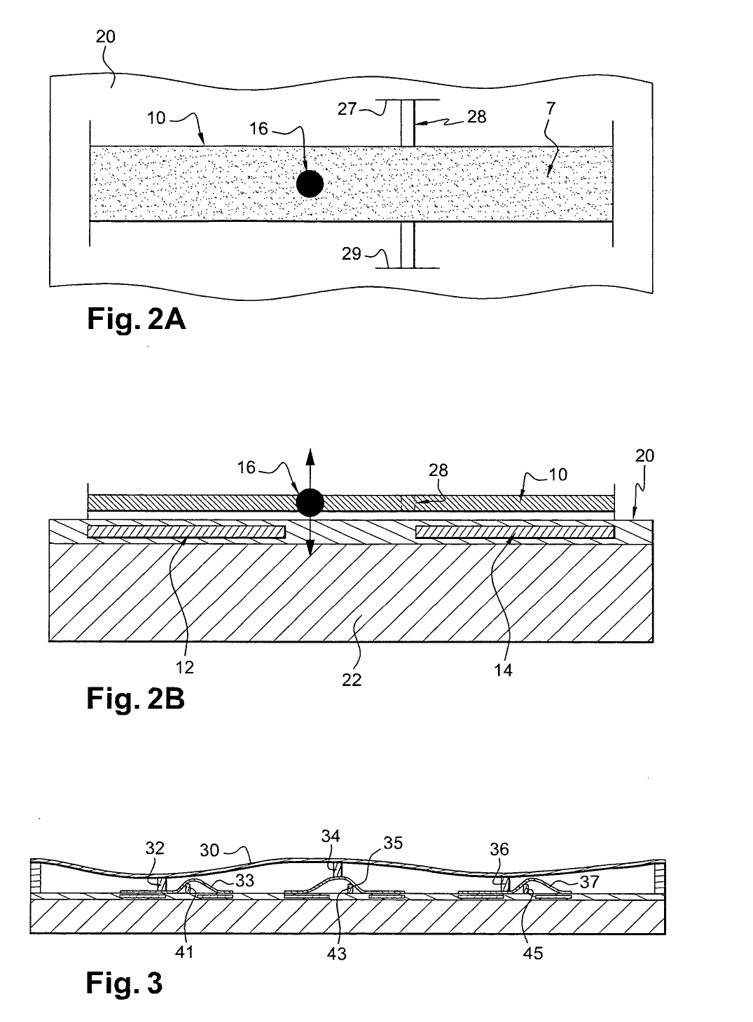

FIGS. 2A and 2B show a top and side view respectively of an embodiment in which the pivot comprises arms 28 extending on each side of the mobile membrane 10, approximately in a plane defined by this mobile part, for example when it is at rest.

In the example in FIGS. 2A and 2B, the ends 27, 29 of these arms are kept fixed with respect to the substrate, using means not shown in these Figures, for example by embedment in this plane.

As a variant, the arms can extend on each side of the mobile membrane but below it, forming a step below which a point on the membrane can never lower in the direction of the substrate.

According to another variant, there is only a single arm on one side. The solution with two arms has the advantage of symmetry, particularly mechanical symmetry of the system.

This embodiment, with one or more arms can generate large forces and limit necking or bonding effects on mechanical parts close to the mobile structure; in the embodiment shown in FIGS. 1A and 1B, the mobile structure can be degraded by friction on the pad 18.

According to one particular embodiment shown in FIG. 3, one or several actuators(s) 33, 35, 37 may be suspended or connected to a membrane 30, each by one pad 32, 34, 36 that maintains a constant distance between the actuator and this membrane. Furthermore, a pivot 41, 43, 45 holds at least one point of each actuator at a minimum distance from the substrate as explained above.

The membrane 30 may be more or less flexible or rigid, for example it may be semi-rigid. It may support optical components, which is one example application to the domain of adaptive optics.

In the above examples, the ends of the mobile membranes 10, 33, 35, 37 may be more or less free with respect to the substrate 22 or the insulating layer 20 that covers it; these lateral ends are not necessarily embedded in or on this layer or this substrate. Thus in the example shown in FIG. 3, the ends of each actuator connected to the membrane 30 by a pad 32, 34, 36 may very well be free.

The ends of the mobile electrode can also be kept in contact with the substrate by the simple effect of low voltages between the mobile electrode and the corresponding fixed electrode.

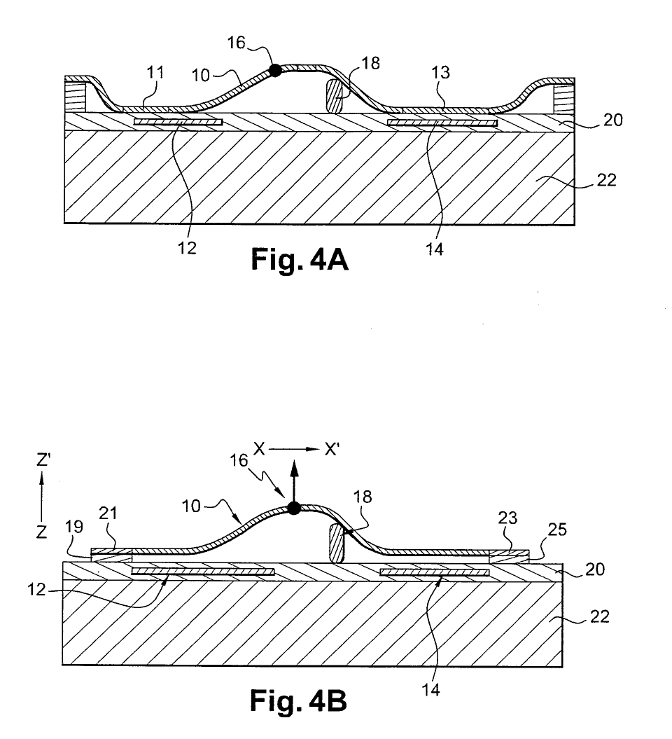

In the embodiment illustrated in FIG. 4A, the ends 11, 13 of the mobile element 10 of the actuator are integrated in or on the insulating layer 20 or the substrate 22. For example, these ends may be fixed on the surface of the insulating layer. According to one variant, only one of the two ends is thus embedded.

According to another embodiment (FIG. 4B), the ends of the mobile element 10 of the actuator comprises magnetic means or magnetic zones 21, 23. The mobile part itself may be partially made of a magnetic material; for example it comprises an insulating layer (for example made of nitride), a first layer of magnetic material (for example FeNi), a second layer of insulating material (for example nitride). Magnets 19, 25, fixed with respect to the substrate 22 are then used to hold the magnetic or magnetised ends of the mobile element fixed with respect to the substrate 22.

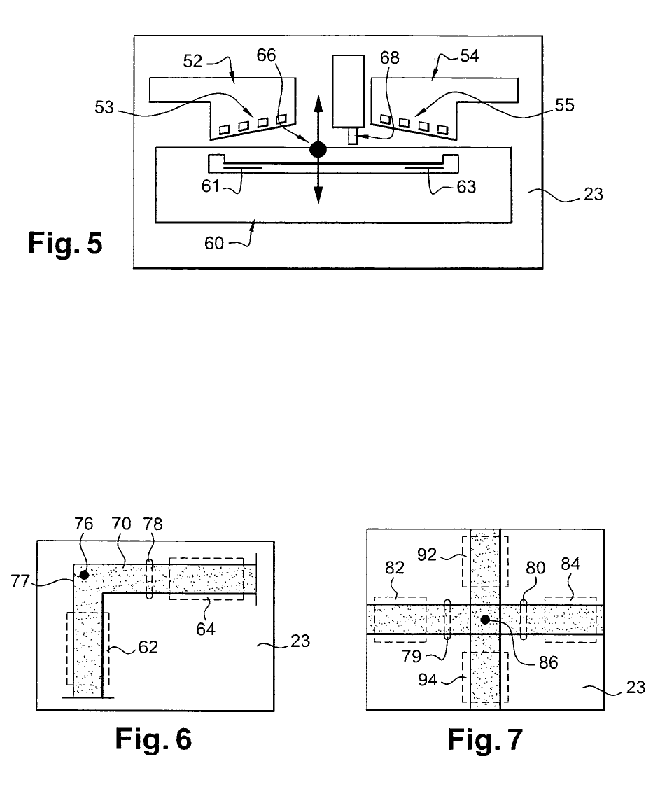

FIG. 5 shows an example of integration of an actuator in a plane, in this case the upper plane of a substrate 23 or an insulating layer deposited on it.

All elements (electrodes 52, 54, beam 60, pivot 68) are formed in this layer or this plane by etching. In particular, a cavity is etched under the beam 60 which is thus released from the substrate and can move like the charge 66 along the arrow indicated in the Figure along a direction approximately perpendicular to the electrodes.

A sacrificial layer used during etching may be made of oxide or a polymer material depending on the selectivity of etching with respect to the structure.

This embodiment is very compact.

According to one variant, magnets 53, 55 are integrated into the electrodes 52, 54, the lateral parts of the beam 60 incorporating magnetic elements 61 63, for example cores made of a magnetic material such as FeNi. The magnets and the magnetic material may be deposited on the mobile structure and on the fixed structure, and protected by a layer that resists etching of the sacrificial layer under the beam 60.

More complex shapes may be made.

For example, the thickness and the shape of the mobile part 60 can be varied. It can be thinner at its ends (as illustrated in FIG. 5) to limit the voltage applied to it, and for which the mobile electrode is pressed into contact on the fixed electrode.

According to another variant, the mobile part 60 may be free at its ends and attached to the pad 68.

In the embodiments presented, the insulator 20 may for example be made of nitride or oxide. In the case in FIG. 5, an insulator, once again for example nitride or oxide, may be formed on the electrode 52, 54, and/or on the mobile electrode 60.

In the various embodiments presented, the different elements of the structure (membrane, electrodes, mobile part, pad) may be made of silicon, or nitride if they are at least partly covered by a metal, or aluminium. Other materials would also be possible.

The actuators can be made in a configuration allowing greater movement. In the configuration illustrated in FIG. 5, the beam applies a natural mechanical resistance to elongation which limits its movement.

The configuration in FIG. 6 is a top view of a substrate 23—pivot 78—beam 70—fixed electrodes 62, 64 assembly. The fixed electrodes are actually located under an insulating layer that covers the substrate 22. The shape of the beam forms an angle or an elbow 77 which gives better movement of the load 76. This angle is a right angle in FIG. 6, but it could also be an angle of less than 90° or greater than 90°.

However, this configuration can rotate the point at which the load is fixed.

The configuration in FIG. 7 compensates for this defect using four arms and four fixed electrodes 82, 84, 92, 94. Facing electrodes 92, 94, and 82, 84 may be connected together. References 79, 80 denote two pivots. Reference 86 denotes the load that is not rotated in this embodiment.

The ends of these embodiments in FIGS. 6 and 7 do not necessarily have to be embedded. They can be pressed in contact with the substrate through voltages, as already mentioned above within the framework of another embodiment.

Once again, the pad 78 may be replaced by arms not shown in FIG. 6, but similar to those shown in FIG. 2A, and arranged on each side of the membrane. As already described above, a single arm is also possible.

During manufacturing, the ends of the membrane will be held in place by the pad 78, or by the lateral arms.

Regardless of the embodiment used, the two parameters for adjustment of the force are the voltages between electrodes.

The choice of the thickness of the mobile membrane provides an easy means of adjusting the stiffness of the actuator for resistance to shocks, vibrations, response times, etc. The actuator becomes more rigid as the mobile part becomes thicker. The voltage to be applied for the same displacement is then greater.

Regardless of which configuration is selected, displacements may also be increased linearly with the length of the mobile parts that form lever arms.

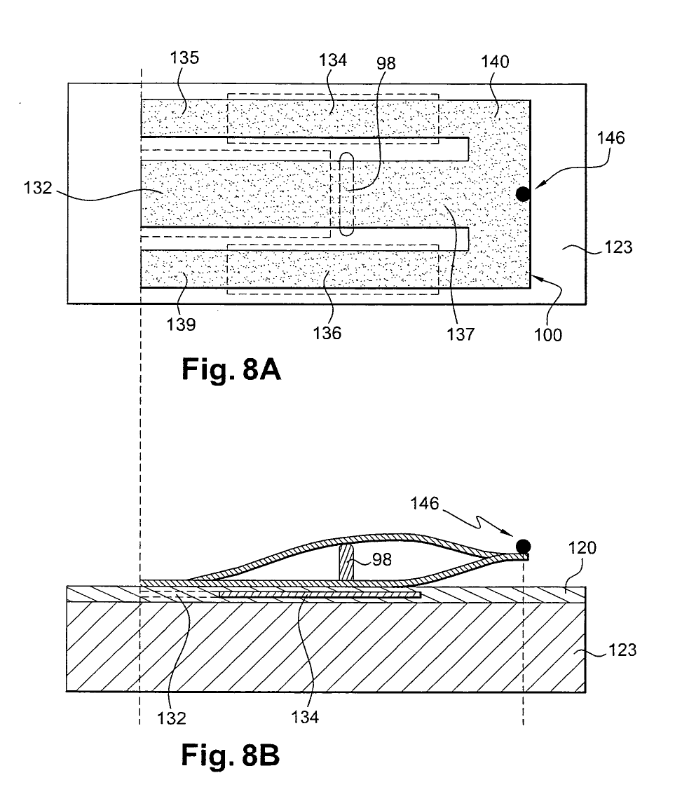

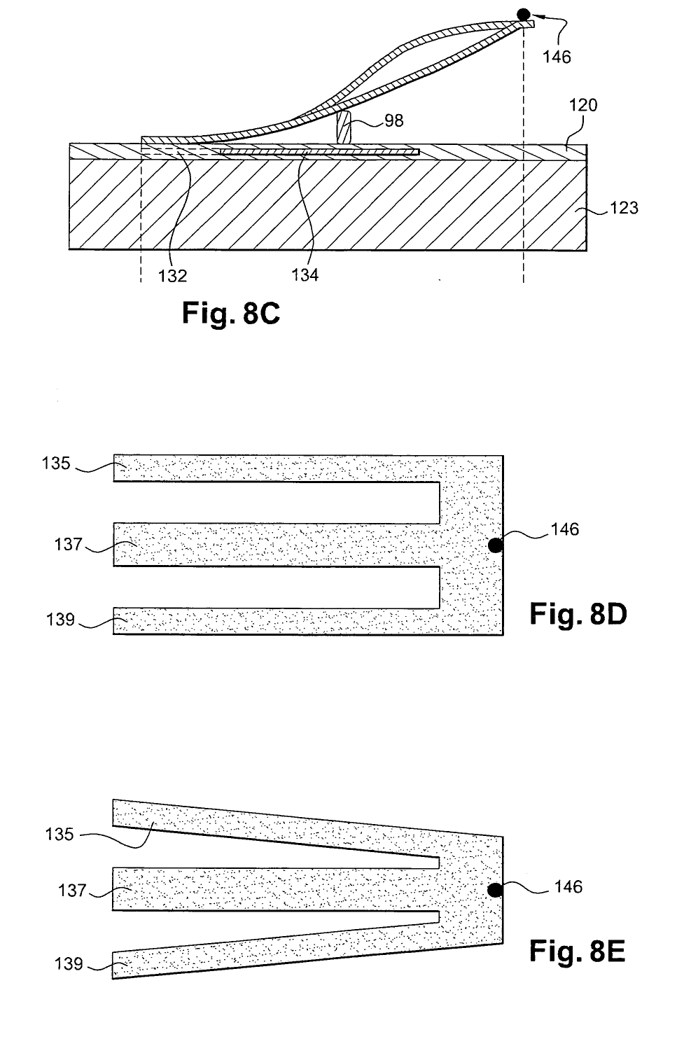

The configuration in FIGS. 8A-8C is more symmetric and also facilitates larger displacements.

Three fixed electrodes (one central electrode 132 and two lateral electrodes 134, 136) are made in a substrate 123.

The mobile part or mobile membrane or mobile electrode comprises three parallel zones or strips 135, 137, 139, the free ends of which are connected through a common part 140 that supports a load 146 and that is approximately perpendicular to it. The other end of each of these strips is kept fixed with respect to the substrate 123, either by an electrostatic voltage or by a fixing or by embedment, or by magnetic means, these different variants having been described above particularly with reference to FIGS. 4A and 4B.

For greater efficiency, the lateral electrodes 134, 136 are offset from the central electrode 132 towards the mobile end 140 of the actuator. It would also be possible but less efficient to make 3 electrodes without any offset between them.

The central part 137 may be supported on a pivot 98. According to one variant, a pivot is provided under each lateral part, but there is no pivot under the central part.

By varying the voltages between the fixed electrodes 132, 134, 136 and the mobile electrode, it is possible to actuate the load in a low position (FIG. 8B) and in a high position (FIG. 8C) with respect to the substrate 123.

Each of the fixed electrodes can be used to press the part of the mobile electrode facing it progressively into contact with the substrate, as a function of the applied voltage.

When the central part 137 of the mobile electrode is attracted towards and pressed into contact with the substrate due to the electrostatic effect, it then bears on the pivot 98, the lateral parts 135, 139 for which the attraction voltages to the substrate are released, moving away from the substrate under the effect of mechanical return forces (case in FIG. 8C), which contributes to moving the load 146 away from the substrate.

When the lateral parts 135, 139 of the mobile electrode are attracted towards and pressed into contact with the substrate by an electrostatic effect, the central part 137 for which the attraction voltage towards the substrate is released, and which then still bears on the pivot 98, moves away from the substrate under the effect of mechanical return forces (case in FIG. 8B) which contributes to moving the load 146 towards the substrate.

When the lateral parts are each supported on a pad and the central part does not have a pivot, the operation of the system as described above is still based on the same principles; namely attraction of lateral parts towards the substrate by electrostatic effect, the central part moving upwards under the effect of mechanical return forces when the attraction voltage to this central part is released; and when the central part is attracted towards the substrate by an electrostatic effect, the lateral parts move upwards under the effect of mechanical return forces when the attraction voltages of these lateral parts towards the substrate are released.

This combined action of firstly electrostatic forces and secondly mechanical return forces result in a large amplitude for the free end 140.

The arms 135, 139 may be moved away from the central part 137, either in the lateral or angular direction, to improve stability at the embedment end. Diagrammatically, FIGS. 8D and 8E respectively show the case of arms moved sideways and arms moved in the angular direction.

The arms 135, 137, 139 are shown as straight lines in FIGS. 8A-8E, but they may be in any shape.

According to one variant, a device according to the invention may include only two arms, for example arms 135 and 137, and for example a pivot under one of the two arms. The device is then less stable.

The invention may also be used to make electrical or optical micro-switches and variable capacitances.

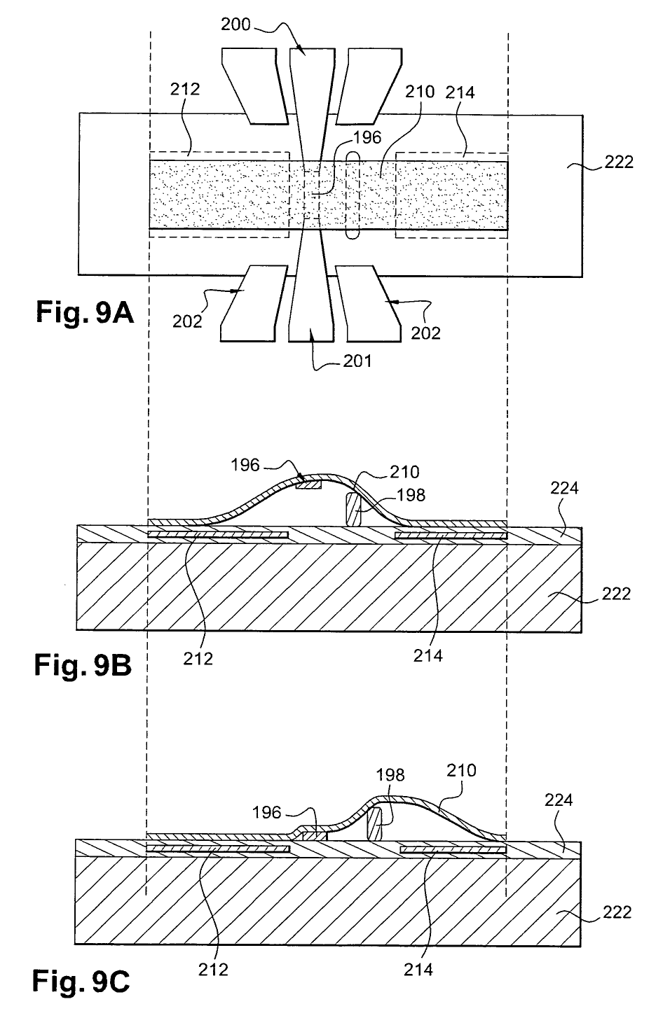

FIG. 9A shows a top view of a electrical switch 196 in the high position, and FIGS. 9B and 9C show a side view of the same switch in the low position.

In these Figures, the actuator is similar to the actuator in FIG. 1A, the load then being an electrical contact 196.

In FIG. 9A, references 200 and 201 denote an electrical input track and output track respectively, reference 202 being a ground strip.

As can be seen in FIGS. 9B and 9C the system is used to control closing and opening of a switch 196. When it is in the low position, this switch closes the circuit between tracks 200 and 201 for example. It may also come into contact with a track of a circuit made in the layer 224, this circuit not being shown in the Figures.

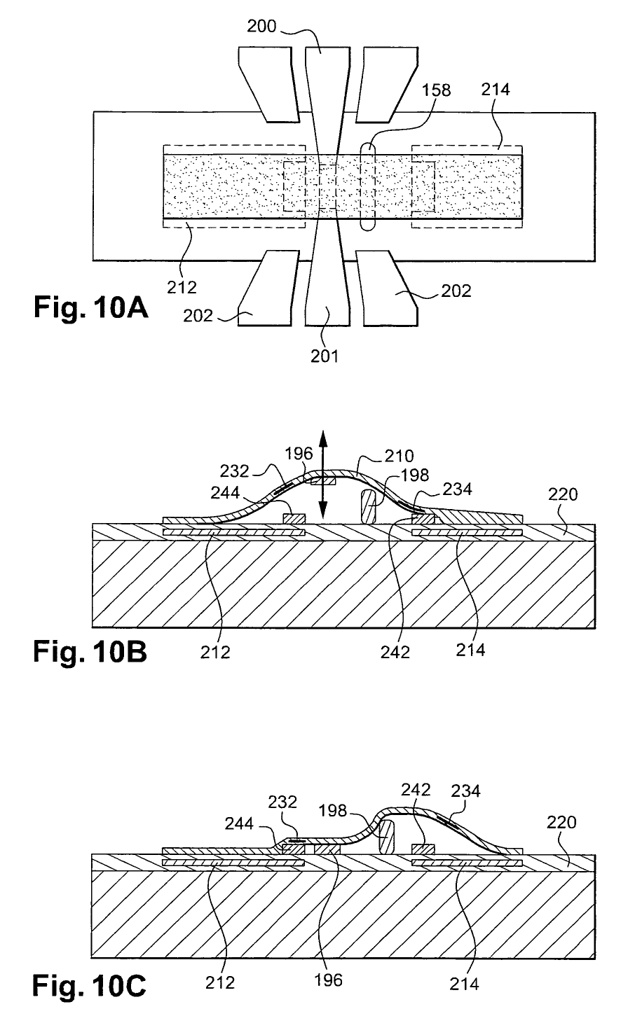

FIG. 10A shows a top view of a bistable switch in the high position, and FIGS. 10B and 10C show a side view of the same bistable switch in the low position.

References identical to those in FIGS. 9 A-C denote similar or corresponding elements.

Magnetic means are also provided: firstly, fixed means 242, 244 on the substrate or with respect to the substrate; secondly the mobile membrane 210 itself is provided with magnetic means; this membrane may be at least partly magnetic or it may comprise portions 232, 234 made of a magnetic material.

The magnetic means 244 are preferably separated from the contact 196 to limit disturbances.

Unlike the system shown in FIGS. 9B and 9C, the system does not consume any electrical energy in the two positions shown in FIGS. 10B and 10C; these are magnetic means that hold the system in the high and low positions.

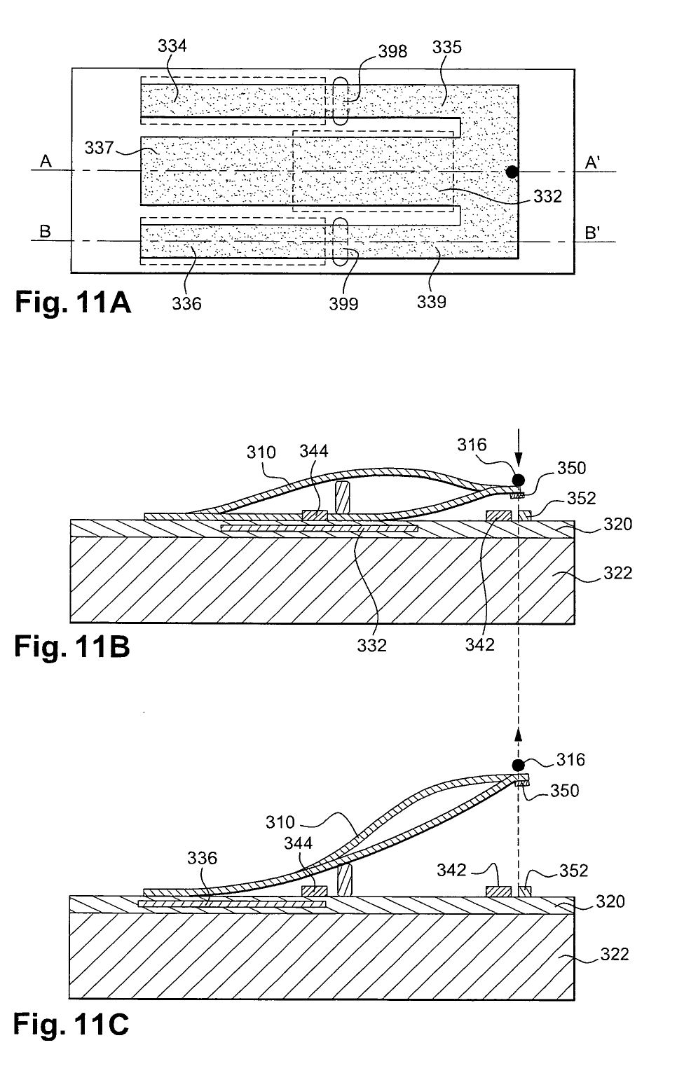

Another embodiment will be described with reference to FIGS. 11A-11C.

In fact, this embodiment is practically the same as that shown in FIGS. 8A-8C, to which magnetic means have been added on the fixed part and on or in the mobile part 310. For example, magnetic pads or magnets 342,344 are placed on the layer 320 that is itself supported on a substrate 322, the beam or the mobile electrode 310 itself comprising magnetic means. For example, it contains a magnetic material, for example iron nitride (FeNi) locally or over its entire length.

Preferably, the magnetic means or the magnetic material incorporated in the mobile electrode 302 is encapsulated so as to protect it during use.

According to one example, the mobile electrode is composed of three superposed layers:
a first layer made of Si₃N₄,
a second layer made of FeNi,
a third layer made of Si₃N₄.

For example, a magnetic layer may be deposited in the same way as magnets 342, 344 are deposited, by electrodeposition or by cathodic sputtering.

The insulating layer (e.g. nitride) may also be discontinuous to reduce the effects of loads.

As can be seen in FIGS. 11B and 11C (seen in sectional views along the AA′ and BB′ axes in FIG. 11A respectively), the device also comprises two parts 350, 352 of an electrical contact, which is closed when the end of the mobile electrode carrying the load 316 is in the low position.

FIG. 11A is a top view of the complete device. Compared with FIG. 8A, the relative positions of firstly the central fixed electrode 332 and secondly the lateral fixed electrodes 334, 336 are inverted.

Furthermore, pads or pivots 398, 399 are provided under each side portion 335,339 of the mobile electrode, but not under its central portion 337.

Only two magnetic pads 342, 344 are shown in FIGS. 11B and 11C. In fact, as shown in FIG. 11A, it is possible to place two or several magnets on the substrate, under the central part 337 of the mobile electrode, and to place two or several magnets on the substrate, under each of the lateral parts 334, 336 of this electrode.

Thus, a set of stable intermediate positions can be defined between the highest position of the load (FIG. 11C) and the lowest position, in other words the position in which the electrical contact 350-352 is closed. This embodiment in FIG. 11B can also form a variable capacitor, for which the means 350, 352 may form armatures, but in stable positions. Such a structure has the advantage that it is not sensitive to vibrations.

Without the magnetic means (and therefore with a structure similar to that shown in FIGS. 8A-8C together with means 350, 352), a variable capacitor with continuous operation is also formed; impedance measurement means are then used to measure the value of the capacitance obtained and to use voltages applied to electrodes to adjust the relative distance of elements of the capacitor as a function of this measurement. However, such measurement means induce noise that affects operation of the capacitor. The embodiment shown in FIGS. 11 A-C, with stable positions predefined by the magnetic means, eliminates this type of impedance measurement means and therefore noise generated by them.

In a system like that shown in FIGS. 11A-11C or 10A-10C combining electrostatic means and magnetic means, the dimensions of the magnets and electrodes will be chosen so as to obtain an electrostatic attraction force at the time of actuation greater than the magnetic force concerned when a contact is made between the mobile part and the fixed part, itself greater than the mechanical return force.

An attempt is also made to size magnets and the electrode surface so as to obtain a sufficient difference between the electrostatic or zipping force and the magnetic force applied at the time of the contact. This difference is preferably at least 10%, so that there is no sensitivity to magnet manufacturing non-uniformities or necking (or bonding) effects between the mobile electrode and the substrate, or the effects of loads in dielectric materials.

The electrostatic or zipping forces and the magnetic forces involved at the time of the contact are greater or very much greater than return forces of the mechanical structure, preferably in a ratio equal to at least 10.

The same considerations are valid for the embodiment shown in FIG. 5, when it comprises magnetic means.

Different variants can be envisaged. In particular, the mobile part may be wound or turned so as to minimise its overall dimensions. Furthermore, the number of arms in this mobile part may be different depending on the application.

In general, a process for making a device according to the invention uses substrate and/or layer etching and layer deposition techniques known in microelectronics. Such techniques are described in documents 1-4 already mentioned.

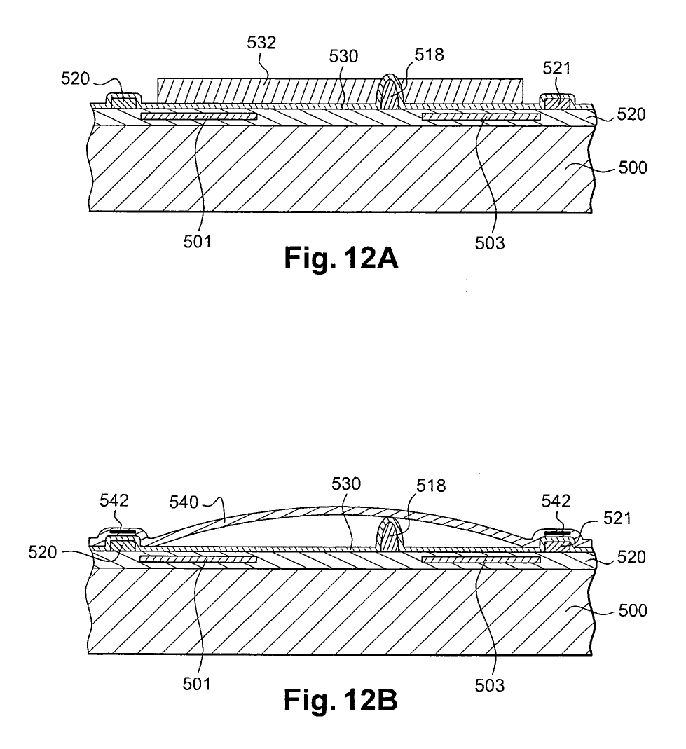

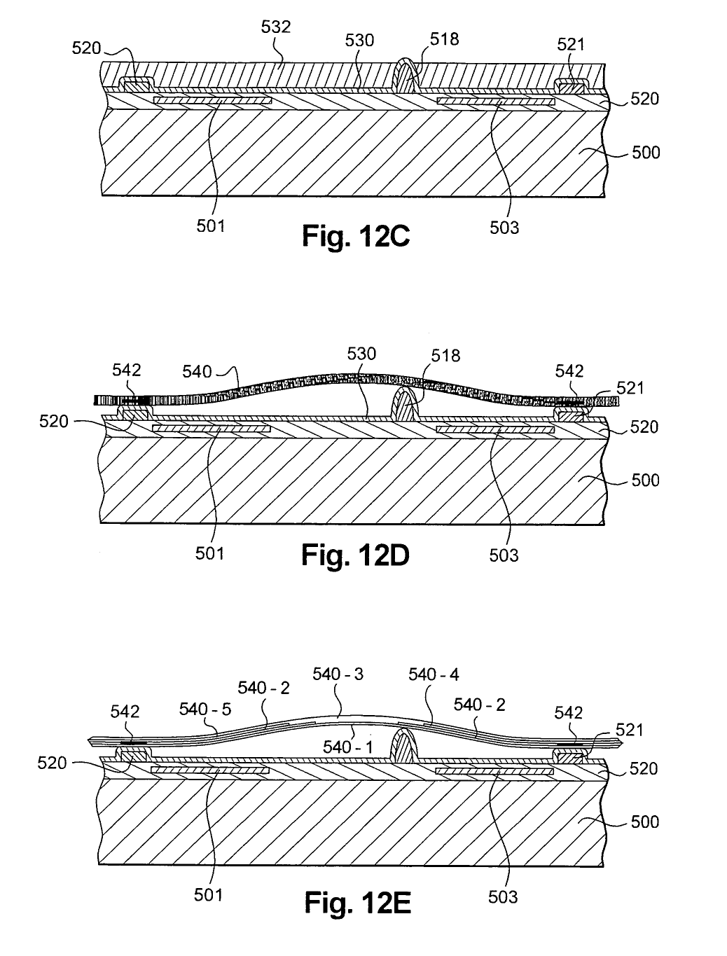

FIGS. 12A-12B show steps in the formation of a device according to the invention, like that shown in FIG. 4B.

An insulating layer 520 and electrodes 501, 503 are formed on a substrate 500 (FIG. 12A), possibly together with magnets 520, 521 by electrodeposition (for example of CO and Pt).

A pad 518 may be formed by deposition of a layer and etching. As indicated in FIGS. 12A and 12B it may be arranged asymmetrically about the fixed electrodes 501, 503 so that the amplitude of a point on the central part of the membrane, possibly a load placed at this point, can be more than the height of the pad.

A first very thin sacrificial layer 530 (for example made of 1.1 μm thick polymer) is deposited followed by a second sacrificial layer 532. The next step is etching, insolation, development of this layer and finally creep.

The next step is to form a mechanical layer 540 (for example made of nitride) and possibly a magnetic layer 542 (for example FeNi). The mobile part or electrode of the actuator can be etched in this mechanical layer 540. The sacrificial layer is then etched, thus freeing the mechanical layer (FIG. 12B).

According to one variant illustrated in FIGS. 12 C-12 D, the sacrificial layer 532 extends beyond the pads 520, 521. The result is that after the sacrificial layer has been removed, the shape of the layer 540 is as illustrated in FIG. 12D, with no contact with the substrate or the layer 530 between the pads 520, 521. The membrane 540 is held in place only by firstly the magnetic means 520, 521, and secondly 542.

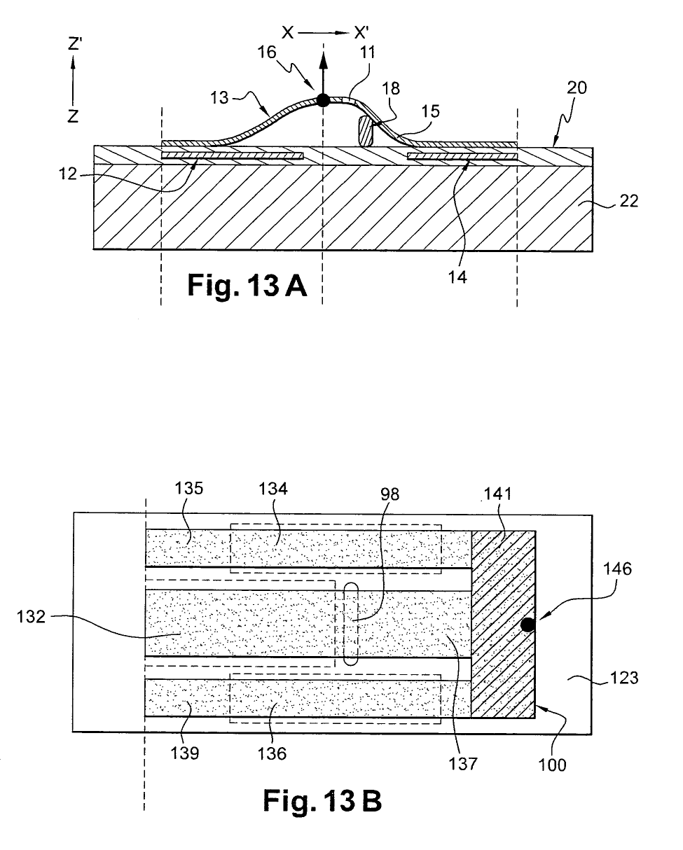

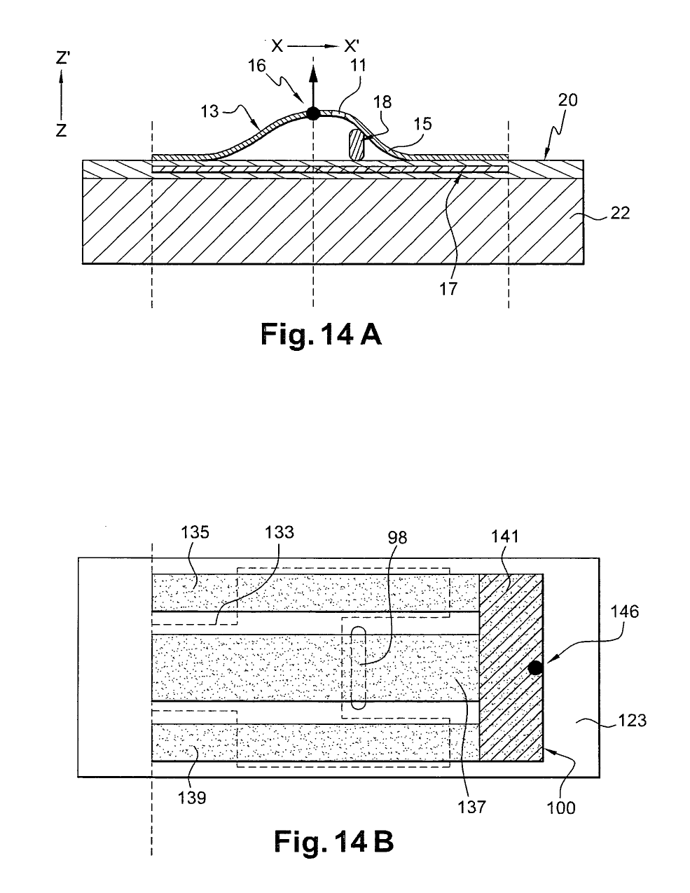

For example, the membrane may comprise a conducting layer on an insulating layer. As illustrated in FIG. 12E, it may also comprise three layers consisting of an insulating layer 540-1 (for example made of nitride Si3N4), one or several electrode layers 540-2, and an insulating layer 540-3 (for example also made of nitride Si3N4). Conductors 540-4, 540-5 connect the conducting zones to voltage supply means (not shown in the Figure). This variant can also be used to make an actuation device as illustrated and explained below with reference to FIGS. 13A-14B.

Variants of this process can be used to adapt membrane shapes and arrangements of the electrodes and magnetic means, for example to make devices like those shown in FIGS. 6, 7, 8A-8 E, 9A-11C. A device without magnetic means can also be made, as already explained above.

In the embodiments presented above, the mobile electrode comprises a flexible part that may be raised uniformly to a given potential and that returns to its initial configuration by mechanical return forces. The potential differences between the mobile electrode and each of the fixed electrodes determine the movement of this flexible electrode, regardless of whether it is of the type illustrated in FIG. 1A (two fixed electrodes) or 8A (three fixed electrodes) or has more than three fixed electrodes. The number of potential differences applied is equal to the number of fixed electrode−mobile electrode pairs.

The invention also relates to the case in which the mobile part is no longer uniformly conducting but comprises at least two conducting parts separated by an insulating portion.

FIG. 13A corresponds to the case in FIG. 1A, but the flexible part has an insulating zone 11 separating two conducting zones 13, 15.

This device operates in the same way as the device in FIG. 1A, a potential difference possibly being applied to each of the conducting parts 13, 15 of the flexible part.

As in the case in FIG. 1A, the number of potential differences (in this case two) applied can be the same as the number of fixed electrode−mobile electrode pairs.

In this variant, each of the fixed electrodes is used to progressively press the mobile electrode facing it into contact with the substrate as a function of the applied voltage.

The mobile electrode, part of which is pressed into contact with the substrate, then bears on the pivot, the other mobile electrode being moved away from the substrate under the effect of the mechanical return forces.

This combined action of firstly electrostatic forces and secondly mechanical return forces can give a large amplitude, greater than the height of the pivot FIG. 13B corresponds to the case shown in FIG. 8A, but the three parallel strips 135, 137, 139 are connected through a common part 141 that is insulating.

This device operates in the same way as that shown in FIG. 8A, and a potential may be applied to each of the conducting parts 135, 137, 139 of the flexible part.

As is the case in FIG. 8A, the number of potential differences (in this case three) applied can be the same as the number of fixed electrode−mobile electrode pairs.

In these two examples, neither the role of the pivot(s) or the load are different from what was described above with reference to FIGS. 1A and 8A. Similarly, explanations given with reference to FIGS. 8A-8C relating to the set of electrostatic forces and mechanical return forces remain valid.

The invention also relates to the case in which the mobile part is no longer uniformly conducting but includes at least two conducting parts separated by an insulating portion, in which the fixed electrodes would be replaced by a single fixed electrode.

FIG. 14A corresponds to the case in FIG. 1A, but the flexible part comprises an insulating zone 11 separating two conduction zones 13, 15. A single fixed electrode 17 is also made in or on the layer 20 or 22.

This device operates in the same way as that in FIG. 1A, a potential possibly being applied to each of the conducting parts 13, 15 of the flexible part independently.

As in the case in FIG. 1A, the number of potential differences (in this case two) applied can be the same as the number of fixed electrode−mobile electrode pairs.

FIG. 14B corresponds to the case in FIG. 8A, but the three parallel strips 135, 137, 139 are connected through an insulating common part 141. Furthermore, a single fixed electrode 133 is made in or on the layer 120 or 123.

This device operates in the same way as that shown in FIG. 8A, a potential can be applied to each of the conducting parts 135, 137, 139 of the flexible part.

As in the case in FIG. 8A, the number of potential differences (in this case three) applied can be the same as the number of fixed electrode−mobile electrode pairs.

In these other two examples, neither the role of the pivot(s) nor that of the load are different from what was explained above with reference to FIGS. 1A and 8A.

Similarly, the explanations given with reference to FIGS. 1A-1B and 8A-8C concerning the set of electrostatic forces and mechanical return forces remain valid.

In the examples in FIGS. 13 A-14B, the number of potential differences applied can be the same as the number of fixed electrode−mobile electrode pairs.

The principle described above with reference to FIGS. 13A-14B may be applied to all other embodiments already described above; unlike these embodiments, mobile electrodes and fixed electrodes can be configured keeping the same number of potential differences to be applied, equal to the number of fixed electrode−mobile electrode pairs.

In particular, a device like that illustrated in FIGS. 13A and 14A may be applied to a system like that illustrated in FIG. 3, the shape of the actuators 41, 43, 45 being illustrated in FIG. 13A or 14A.

Similarly, the ends of actuators in FIGS. 13A, 14A may be fixed with respect to the substrate as explained with reference to FIGS. 4A and 4B.

Concerning the embodiments in FIGS. 13B and 14B, the ends of each strip (on the side opposite the insulating zone 141) are held fixed with respect to the substrate 123, either by electrostatic voltage or by fixing or embedment or by magnetic means, these different variants already having been described above, particularly with reference to FIGS. 4A and 4B.

The devices in FIGS. 13A and 14A are applicable to manufacturing of electrical switches like those shown in FIGS. 9A-9C, or bistable switches like those shown in FIGS. 10A-10C.

The variants of FIG. 8D or 8E or 11A (two side pivots, no central pivot) are equally applicable to the devices in FIGS. 13B and 14B. These devices in FIGS. 13B and 14B are equally applicable to manufacturing of switches like those shown in FIGS. 11B, 11C.

Loads such as loads 16, 146, 316 can also be applied to the devices shown in FIGS. 13A-14B.

In all of the embodiments explained above with reference to FIGS. 1A-14B, the number of potential differences applied can be the same as the number of fixed electrode−mobile electrode pairs.

The mobile electrode or mobile membrane can bear on the pivot when one of the fixed electrode attracts the mobile electrode or the part of the mobile electrode facing this fixed electrode, the other part of the mobile electrode being able to move away from the substrate under the effect of mechanical return forces.

Therefore an actuator according to the invention uses two types of forces with different natures; electrostatic forces during attraction of a portion of the mobile part towards the substrate and mechanical return forces when this electrostatic attraction is released.

Therefore, the flexibility of a mobile electrode or a mobile membrane of an actuator according to the invention is such that it can be progressively pressed into contact with the fixed part of the device as a function of the voltage, and a stiffness or combined shape and/or dimension and/or nature of material characteristics so that it will return to its initial position not in contact with the substrate, when the electrostatic voltage is released.

As already mentioned above, this combined effect of different natures of electrostatic and mechanical forces enables the movement amplitude of the mobile part to be greater than the height of the means forming the pivot.

Therefore a process for operation of an actuator according to the invention comprises the following steps:
preferably progressive application of a voltage between a part of the mobile electrode or the mobile membrane and a fixed electrode,
possibly release of a voltage applied beforehand between the other part of the mobile electrode or the mobile membrane and a fixed electrode.

The invention is applicable to the case of micro-mirrors or micro-lenses that can be electrically actuated in rotation.

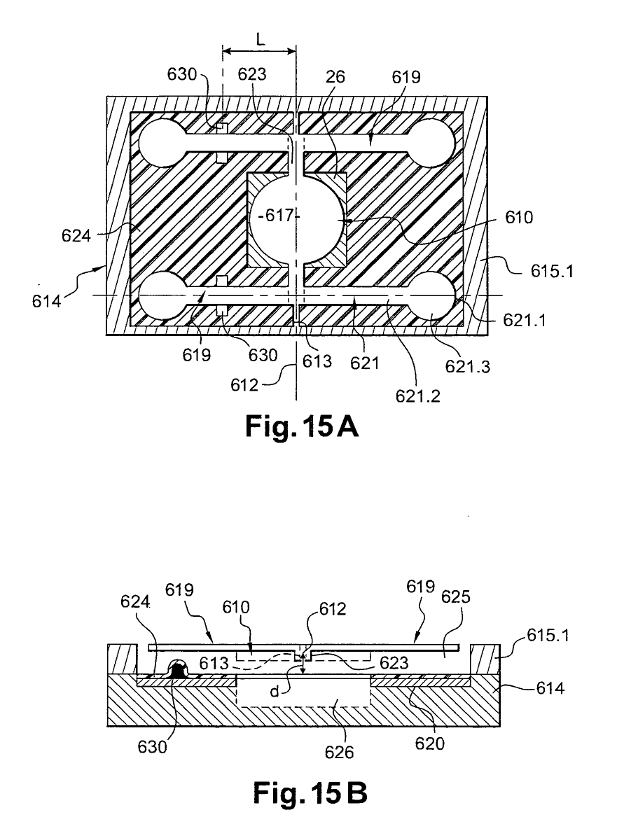

A first example of a micro-mirror or micro-lens according to the invention is shown in FIGS. 15A and 15B.

The micro-mirror or micro-lens comprises a mobile part 610 and a fixed part 614. The mobile part 610 is globally in the shape of a plate (for a micro-mirror) or a frame (for a micro-lens). It is designed to be moved in rotation about an axis 612. The axis passes through the mobile part 610 and is approximately parallel to a main plane of the mobile part 610. Means 613 of connecting the mobile part 610 with the fixed part 614 materialise this axis 612. These connecting means may be in the form of two torsion arms 613 derived from the mobile part 610 and have one end fixed to the fixed part 614 (for example by embedment).

The two torsion arms 613 are in line with each other.

The mobile part 610 is thus suspended above the fixed part 614.

The mobile part 610 comprises main faces, one of which faces the fixed part 614 and the other of which is provided with a reflecting zone 617 (cross-hatched) that will reflect light in the case of a micro-mirror. The reflecting zone 617 is shown as only partially occupying the face of the mobile part 610 but it could occupy it fully.

In the case of a micro-lens, the zone 617 represents a refracting zone, this could be a lenticular refracting part, fixed for example by bonding to the frame 610. The axis 612 can pass through the geometric centre of the mobile part 610.

The micro-mirror or the micro-lens also comprises electrical means of controlling the rotational displacement of the mobile part 610.

In the example in FIG. 15A, these means comprise two zipping effect actuators 619, and addressing means (not visible in FIGS. 15A and 15B) of these actuators.

A zipping effect actuator 619 means the following, as above:
either an actuator formed from two pairs of electrodes 620, 621, with two fixed electrodes 620 (FIG. 15B) and one mobile electrode 621 with a free end 621.1, the mobile electrode 621 being designed to come into contact with the fixed electrode 620 from its free end 621.1, it being brought into contact on a variable surface area as a function of an applied voltage between the two electrodes;
or, for each actuator or for one of the actuators, as explained above with reference to FIGS. 13A-14B, two electrodes in the mobile part of the said actuator or each actuator, separated by an insulating zone, and only one or two fixed electrodes (as for example shown on the diagrams in FIGS. 13A and 14A).

When the voltages between the mobile and fixed parts are released, the corresponding part of the actuator returns to the initial position at a distance from the substrate, under the effect of mechanical return forces.

These two types of actuators can be combined in a single device:
the two actuators 619, each being of the type with two mobile electrodes insulated from each other, but one being positioned facing a fixed electrode and the other facing two fixed electrodes,
or one of the actuators 619 being of the type with two mobile electrodes insulated from each other, but being positioned facing a fixed electrode or two fixed electrodes, while the other actuator 619 is of the type with a single mobile electrode positioned facing the two fixed electrodes.

In all cases, the mobile electrode 621 or the actuator 619 is flexible or supple as in the examples already described above, and operates as already mentioned above.

Each fixed electrode 620 is fixed to the fixed part 614 (FIG. 15B). Each actuator 619 is fixed to one of the two drive arms 623 that projects from the mobile part 610 and that is directed along the rotation axis 612. This drive arm 623 is sufficiently rigid, but it may be driven in rotation about the axis 612.

The actuators 619 may be addressed or actuated either separately or simultaneously as will be seen later.

The size of the mobile part 610 may be between 100 μm or a few hundred micrometers and few millimetres or 5 mm, and a thickness of about a few tens of micrometers, or between 10 μm and 100 μm. Obviously the indicated dimensions are not limitative.

The mobile part is preferably sufficiently stiff such that the reflecting or refracting zone 617 that it carries remains as plane as possible, so as to maintain its optical quality regardless of the conditions and particularly during accelerations.

The mobile electrode 621, or the mobile part of the actuator 619, may be in the shape of an approximately straight body 621.2 starting from the drive arm 623, with an approximately constant width terminating at its free end 621.1 by an end part 621.3 that may be the same width as the body 621.2, or advantageously can be wider than the body (as illustrated in FIG. 15A). In this case, the end part 621.3 may be qualified as a starter.

In FIG. 15A, the two actuators 619 are distributed on each side of the optical component 610, and the two bodies 621.2 are approximately parallel to each other or extend along two directions approximately parallel to each other. However, other forms would be possible.

The fixed electrode 620 may be of an arbitrary shape to the extent that the mobile electrode 621 can be pressed into contact with it or onto the dielectric layer 624 that covers it. As mentioned above, there may be several fixed electrodes in some embodiments, particularly embodiments using the principles of the devices in FIGS. 1A and 13A already commented upon above.

Therefore the fixed electrode may consist of a single electrode for all mobile electrodes or there may be two or three or four conducting zones insulated from each other, thus forming two or three or four fixed electrodes for the mobile electrodes respectively.

A starter 621.3 wider than the body 621.2 reduces the voltage or the attraction threshold Vc and the separation threshold voltage Vd of the corresponding mobile electrode.

When an actuator 619 is at rest, no actuation voltage is applied to it, its two mobile parts being brought into one position not in contact with the substrate due to the mechanical return forces. The mobile and fixed electrodes 620, 621 are then separated by a space 625 that may be full of a gas (air or other) or that may contain a vacuum. This inter-electrode space 625 is illustrated in FIG. 15B. It may be delimited by the frame 615.1. It is preferable to place a layer of dielectric material 624 in this space 625 between the fixed electrodes 620 and the mobile electrodes 621 to prevent a short circuit when a mobile electrode 621 comes into contact with a fixed electrode 620.

This dielectric layer 624 can be seen in FIG. 15B, and it covers the fixed electrodes 620. The thickness of the dielectric layer 624 may be between a minimum value and a maximum value, the minimum value possibly being determined by the breakdown of the insulator to which an electric field is applied generated by a given actuation voltage, applied between the two electrodes of an actuator, the maximum value being determined by the maximum distance between the two electrodes of an actuator when the mobile part 610 is in the rest position without the attraction force being too small for a given actuation voltage. For example, for an actuation voltage of 100V, the minimum thickness of the dielectric layer 624 (for example made of oxide or nitride of a semiconducting material, for example silicon) may be about 0.2 micrometers.

For guidance, the mobile electrode 621 may have:
a length between a few tens of micrometers and a few millimetres, for example between 10 μm or 20 μm and 1 mm or 5 mm or 10 mm,
a thickness of between a few tens of micrometers and a few micrometers, for example between 0.1 μm and 10 μm; the thickness makes the mobile electrode 621 sufficiently supple or flexible in a direction approximately perpendicular to the main plane of the base 614,
and a body width 621.2 very much greater than its thickness, for example between 50 μm and 100 μm thick. The inter-electrode space 625 may be between a few micrometers and a few tens of micrometers at rest.

It is advantageous if the fixed part 614 comprises a recess 626 facing the mobile part 610 (FIG. 15B). The mobile part 610 can penetrate into the recess 626 when it is moved into an inclined position with a large angle. An inclined position with such an angle of inclination would not be possible if the recess 626 was not present because the mobile part 610 would collide with the fixed part.

The fixed electrodes 620 are preferably located on the fixed part outside the recess 626 so as to keep the inter-electrode space 625 relatively small when the actuators are in the rest position.

The depth of the recess 626 is chosen to be sufficient such that the mobile part can be inclined at an angle θmax without colliding with the fixed part 614. The angle θmax corresponds to the maximum angle occupied by the mobile part when the addressing means output a maximum actuation voltage.

The recess 626 may be a hole passing through the fixed part 614 or simply a blind hole in this fixed part 614.

If it is a through hole, it can be made starting from the face of the fixed part 614 on which the fixed electrodes 620 will fit (this face is said to be the front face), or starting from the other face which is said to be the back face.

This recess 626 will be made by dry etching or preferably by wet etching in the material from which the fixed part 614 is made, usually a semiconducting material.

In this configuration, the drive arms 623 are prolonged by the torsion arms 613 as shown in FIG. 15A.

The actuators 619 may be located on each side of the mobile part 610, as illustrated in FIG. 15A.

But this is not compulsory and it would also be possible to have only one actuator 619 on one side of the support of the optical component 610.

With reference to FIG. 15A, it would possible to have only one of the two actuators shown, for example the actuator seen in section in FIG. 15B.

In practice, a torsion arm 613 will have a smaller cross-section than a drive arm 623, this cross section assuring a certain flexibility in torsion. The cross section of the drive arm 623 is larger so that it remains rigid during the drive.

Thus, the dimension of the torsion arms 613 may be optimised so that they are sufficiently flexible in torsion and sufficiently stiff in vertical bending. They are advantageously relatively thick and their width will be less than their thickness.

If the torsion arm 613 is not sufficiently stiff in vertical bending, the actuator 619 may tend to pull the mobile part 610 downwards rather than drive it in rotation. The movement of the mobile part 610 may then not be a pure rotation, which can give a lateral translation movement to a reflected or transmitted light beam resulting from a light beam incident on the reflecting or refracting zone 17. This additional translation effect may also be beneficial and in this case the fact that the torsion arm 613 is not sufficiently rigid in vertical bending would be advantageous.

At least one of the actuators 619 comprises means 630 forming a pivot for its mobile electrode or its mobile electrodes 621.

These means 630 will form a pivot in a zone placed between a zone of the actuator connected to the drive arm 623 and a free end 621.1 of the actuator.

The means 630 forming the pivot may be formed by at least one pad fixed with respect to the fixed part 614, as explained above with reference for example to FIG. 1A, 1B or 4A, 4B. Each pad then projects from the fixed part 614 towards the mobile part 621.

Conversely, one of the pads 630 may be fixed to the mobile electrode 621 and project towards the fixed part 614.

For the actuator provided with a pad, the pad forms a bearing zone for the mobile electrode 621, when it is attracted by the fixed electrode 620.

As a variant, the means 630 forming the pivot may be formed from at least one side arm with the mobile electrode 621 connecting the mobile electrode 621 to the fixed part 614. The arm 630 may be as described above with reference to FIG. 2A, or it may project from the mobile electrode and it may have an end fixed to the fixed part 614, for example by embedment.

Two arms, arranged on each side of the mobile electrode, make the structure symmetric. A better lateral stability of the mobile electrodes is then achieved.

As already described above with reference to FIGS. 1A-14B, the means 630 forming the pivot are used to maintain a zone or a portion of the mobile electrode 621 at a distance from the fixed part 614 when the free end of the mobile electrode 621 is attracted by the fixed electrode 620.

The distance L between the zone in which a pivot of the mobile electrode and the portion of this mobile electrode or these actuator means connected to the drive arm 623, enables a lever effect so that the mobile part 610 can be inclined. The edge of the mobile part 610 located on the same side of the axis 612 as the mobile electrode or the actuator 621 that is pressed into contact with the fixed electrode 620, moves upwards and the opposite edge moves downwards.

With this configuration, the distance d between the axis of rotation 612 and the fixed part 614 at the contact surface may be of the order of a few micrometers, for example d is between 3 μm and 10 μm.

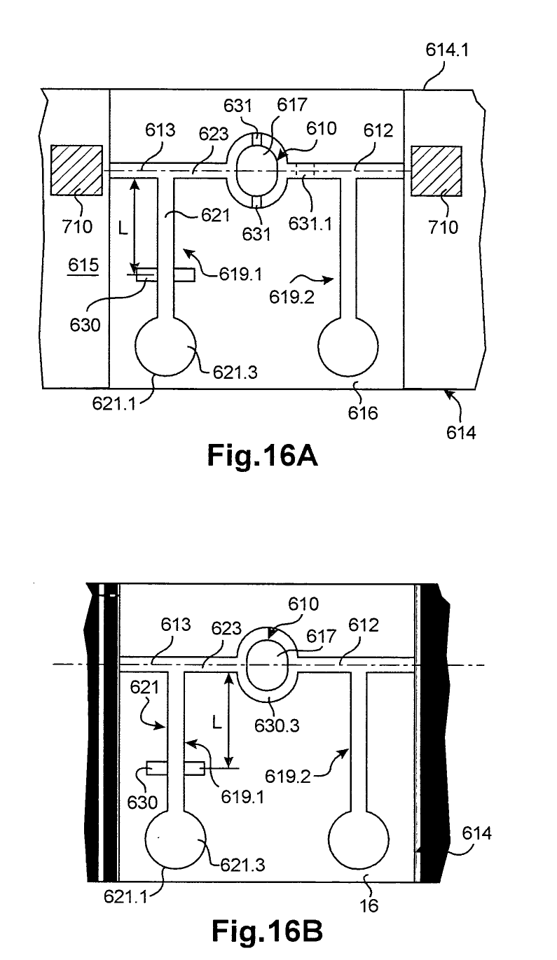

A device can be made with an actuator with means 630 forming the pivot, as illustrated in FIG. 16A. The actuator then comprises two parts 619-1 and 619-2 separated by an insulating portion 631, and can be located facing one or two fixed electrodes (based on the principle that was described above with reference to FIGS. 13A and 14A).

In fact, this insulating part may be inserted in means forming the support of an optical component 617, as illustrated in FIG. 16A. They could also be located as illustrated in 631-1, offset from these means forming the support.

In FIG. 16B, the mobile part does not contain an insulating part; it is then a single mobile electrode located facing two fixed electrodes as explained above, for example with reference to FIG. 1A (the fixed electrodes cannot be seen in FIG. 16B but they are contained in the substrate or the fixed part 614).

In the cases illustrated in the two FIGS. 16A and 16B, the mobile part (therefore including the two parts 619-1, 619-2 and the two arm portions 623 located on each side of the support means 610 of the optical component) is located on only one side of the axis 612.

This configuration has the advantage that the mobile means 610 forming a support to the optical component 617 are positioned close to an edge 614.1 of the fixed part 614. The structure obtained is more compact than in the embodiments described above with reference to FIGS. 15A and 15B. Such a structure is particularly attractive during integration of a component 617 such as a micro-mirror or a micro-lens in an optical system.

The device in FIGS. 16A and 16B also comprises means 630 forming a pivot, that can have one of the shapes already described above with reference to any one of the embodiments.

Another advantage of the configurations in FIGS. 16A and 16B is that the mobile part 610 may rotate in both directions with respect to a rest position obtained when none of the actuators 619 is activated.

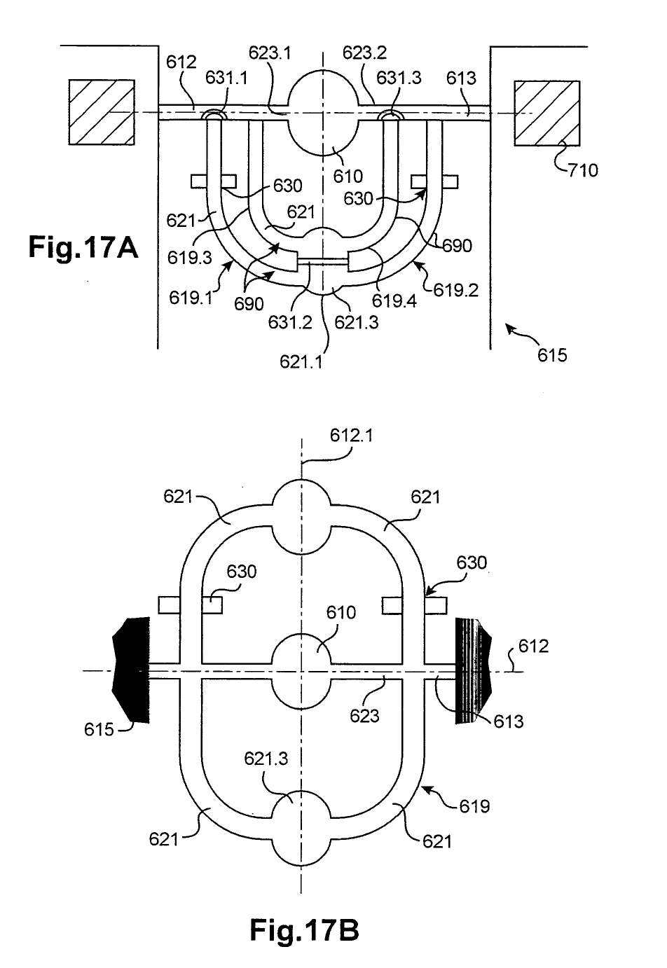

FIGS. 17A, 17B illustrate other configurations of an optical device according to the invention.

FIG. 17A shows two actuators, firstly 619.1, 619.3 and secondly 619.2, 619.4, located on the same side of the axis 612.

Each actuator comprises two folded parts such that the two corresponding free ends are connected to the same side of the mobile means 610. Each actuator thus cooperates with a drive arm 623.1, 623.2 located on one side of the mobile part 610.

Part of each actuator comprises means 630 forming a pivot.

The free ends 621.1 and 621.3 of the mobile electrodes of these two actuators may be mechanically common, as illustrated in FIG. 17A. The starters 621.3 of these mobile electrodes may also be fixed together.

In each actuator, one of the actuator arms 619.1, 619.2 is provided with means forming the pivot 630 and the other arm 619.3, 619.4 does not have such means.

Therefore, each actuator operates on the principle that was already described above with reference to FIGS. 1A-16B; one of the parts may be attracted towards the substrate by an electrostatic effect, while the other part is subject to a mechanical return that moves it away from the substrate.

References 710 that can be seen in FIG. 17A (and in 16A) illustrate contact pads fixed on the frame (or the uprights) 615; these pads are designed to supply power to the mobile electrodes of the actuators.

One and/or the other of the actuators may comprise one or two mobile electrodes (as explained above with reference to FIGS. 1A, 13A, 14A), and a number of fixed electrodes such that the actuator can be controlled by two different voltages.

In FIG. 17A, each actuator is actually composed of two parts each forming a mobile electrode, these two parts being separated from an electrically insulating zone 631.2. In fact, considering the mechanical link between the free ends of the two actuators, a single insulating portion 631.2 is sufficient for the two actuators.

As already mentioned above, the two actuators have their other ends connected to the drive arms 623.1 and 623.2. Each drive arm is provided with an electrically insulating zone 631.1 and 631.3 for this purpose.

In the configuration in FIG. 17A, an axis perpendicular to the rotation axis 612 passing through the centre of the mobile part is an axis of symmetry for the two actuators.

The configuration in FIG. 17B also comprises two actuators distributed on each side of an axis 612.1 perpendicular to the axis 612. The mobile parts 621 of the actuators that are located on the same side of the axis 612 are terminated with a common starter 621.3. Means 630 forming pivot are associated with each actuator. Non-simultaneous actuation of the two actuators can drive the mobile part 610 in rotation, but simultaneous actuation of the two actuators will drive the mobile part 610 in upwards translation, and it will then move away from the fixed part 614.

In the case shown in FIGS. 17A and 17B, the actuators are curved in shape, so that a mechanical link can be made between them.

We will now describe an example of a method for manufacturing a device (for example a micro-mirror or a micro-lens) according to the invention. It is assumed that the addressing means apply appropriate voltages onto the mobile electrodes of the actuators to displace the mobile part in rotation, while the fixed electrodes are brought to a constant voltage (usually the ground). But other schemes for assignment of voltages could be envisaged.

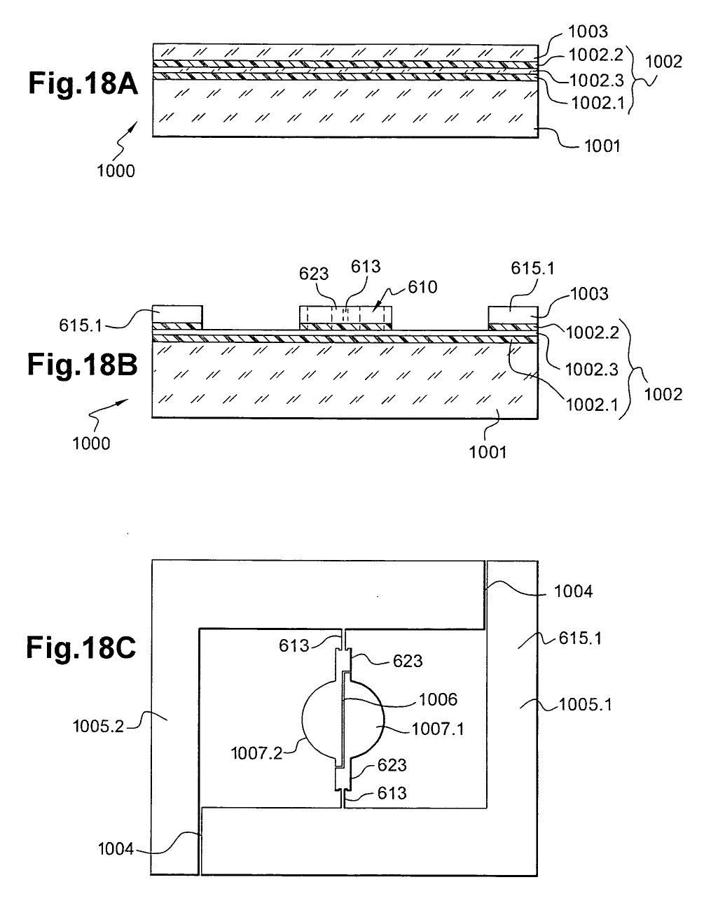

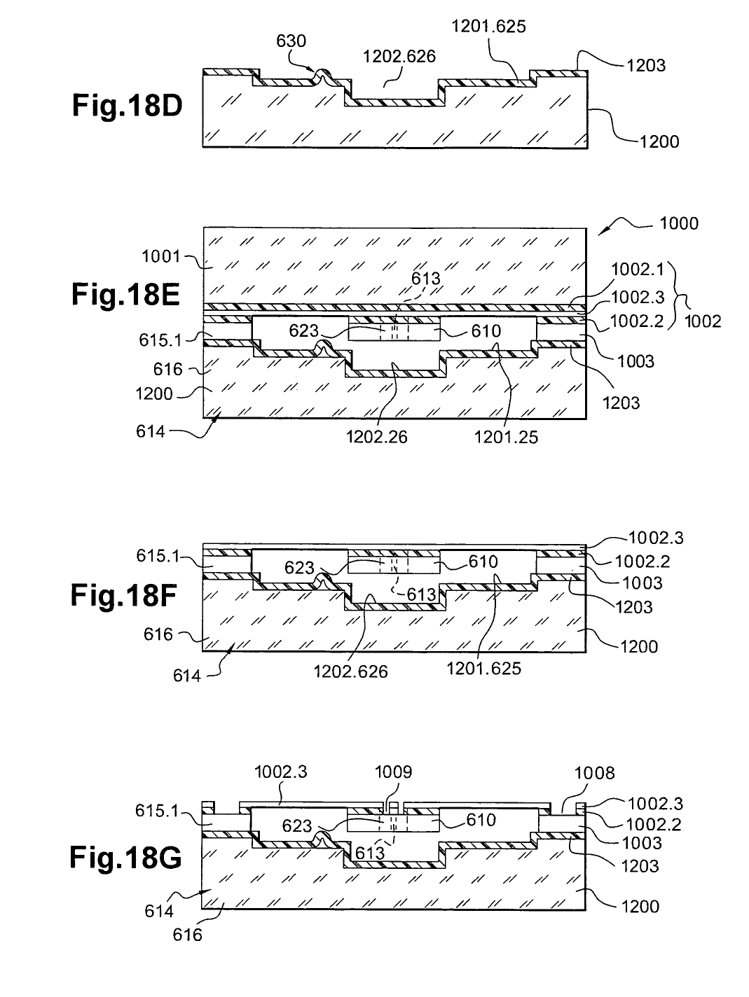

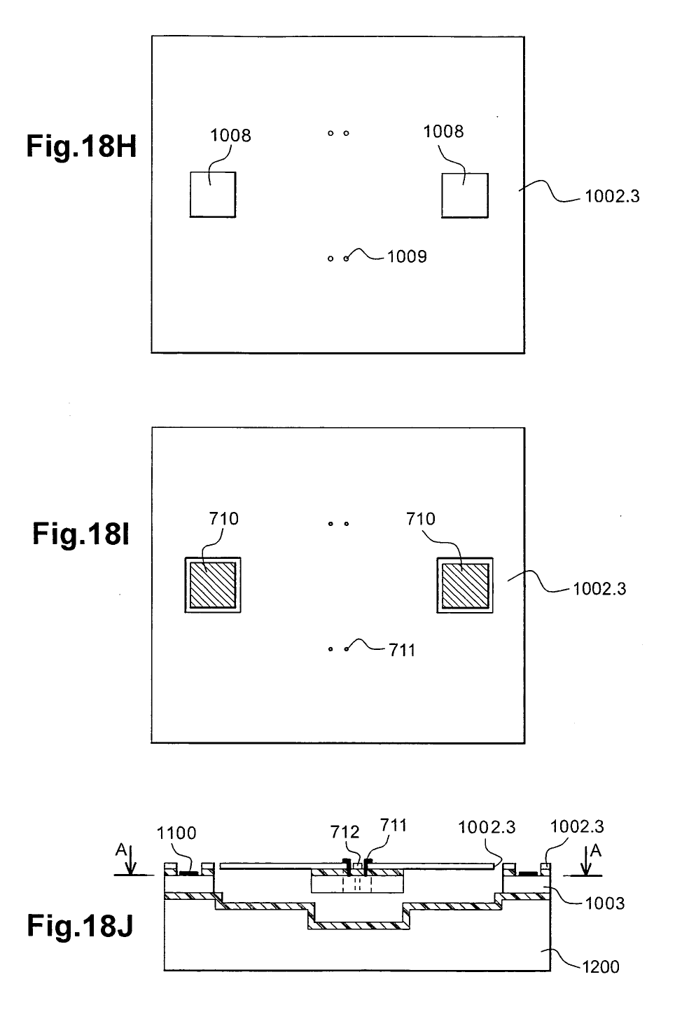

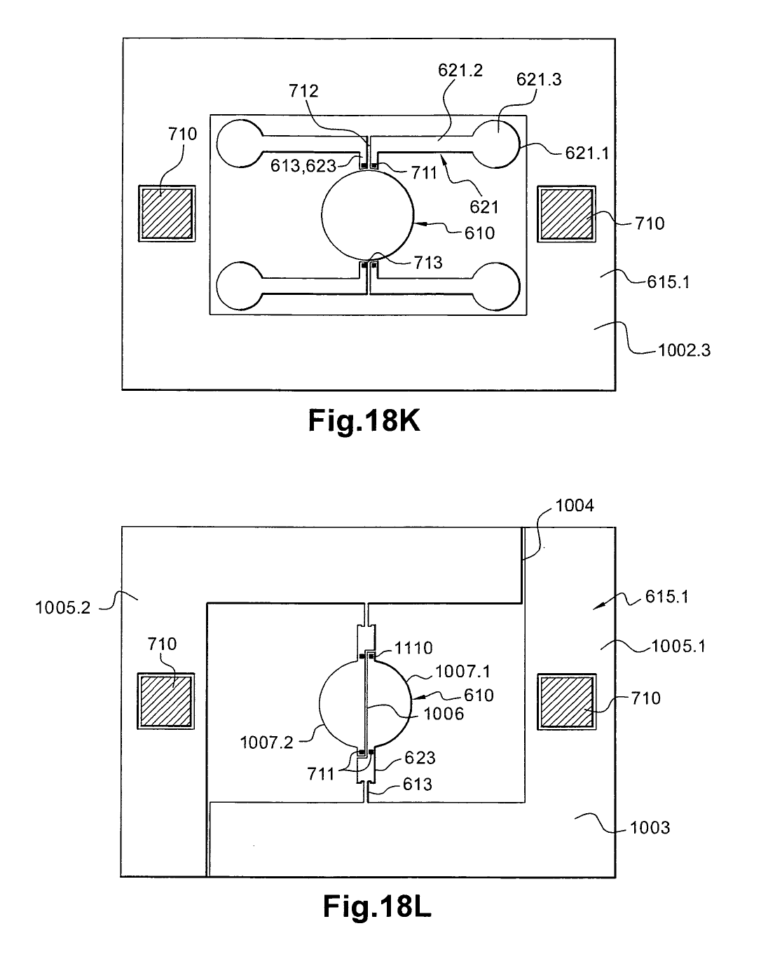

Refer to FIGS. 18A to 18L. It is assumed that the semiconducting substrates are conducting.

A first substrate 1000 formed from a base layer 1001 made of a semiconducting material, for example silicon, is used covered by a sandwich 1002 formed from two insulating layers 1002.1, 1002.2 (for example made of silicon oxide) located on each side of an intermediate layer 1002.3 made of semiconducting material (for example silicon), the sandwich 1002 itself being covered by a surface layer 1003 made of a semiconducting material (for example silicon).

This substrate is illustrated in FIG. 18A. The insulating layer referenced 1002.1 is the lower layer of the sandwich and the layer 1002.2 is the upper layer of the sandwich.

Such a substrate 1000 may be a double SOI (Silicon on Insulator) substrate. The surface layer 1003 is thicker than the intermediate layer 1002.3. The layers made of semiconducting material 1001, 1002.3, 1003 are conducting.

In this example it is assumed that the micro-mirror or the micro-lens is similar to that in FIGS. 15A, 15B, the drive arms 623 and the torsion arm 613 are end to end.

We will begin by delimiting the pattern of a first region of the fixed part 614, namely the frame 615.1 or the uprights of a first region of the mobile part 610, from a first region of the torsion arm 613 and the drive arm 623, by a photolithography step. The next step is to etch these different elements in the surface layer 1003 and in the upper insulating layer 1002.2 (FIG. 18B). This etching step may be a dry etching step. Therefore, the first regions are formed from a semiconducting material of the surface layer 1003 and the material in the upper insulating layer 1002.2.

The mobile part 610 may remain entire or it may be etched, for example so as to obtain a frame with a central recess, depending for example on whether a micro-mirror or a micro-lens is being made. An enclosed etching is shown in dashed lines in FIG. 18B.

The mobile electrodes of the actuators will be made later in the intermediate layer 1002.3.

The torsion arms 613, the frame 615 and the mobile part 610 will be used to route addressing signals to the mobile electrodes of the actuators. These addressing signals propagate in the frame and the torsion arms from contact pads supported by the frame and that will be made later.

For example, one of the torsion arms will be used for addressing actuators located on one side of the axis 612 and the other torsion arm will be used for addressing actuators on the other side of the axis 612.

Insulating trenches 1004 at the frame 615.1 and an insulating trench 1006 at the first region of the mobile part 610 can be made in the surface layer 1003 and also in the upper insulating layer 1002.2 (FIG. 18C), so that the addressing signals intended for the mobile electrodes located on one side of the axis 612 do not propagate to the mobile electrodes located on the other side of the axis that will receive other addressing signals. These trenches may be trenches of air or they may be filled with a dielectric material later.

If two uprights are to be provided instead of a frame, these uprights are electrically insulated due to their configuration.

The insulation trenches 1004 intersect the frame 615.1 in two parts 1005.1, 1005.2, one part 1005.1 carrying one of the contact pads transmitting addressing signals and the other part 1005.2 carrying the other contact pad transmitting the other addressing signal. The pads are not visible at this step (FIG. 18C).

Similarly, the surface layer 1003 corresponding to the first region of the mobile part 610 is separated into two parts 1007.1, 1007.2 by the insulating trench 1006.

One of the torsion arms projects from one of the parts 1007.1 and the other projects from the other part 1007.2. The insulating trench 1006 is directed mainly along the axis of rotation 612. The insulation trench 1006 can be seen in FIG. 18C.

In a second semiconducting substrate 1200 (for example made of silicon) that will be used as the second region of the fixed part 614, namely the base 616, a first setback part 1201 is made by etching and will contribute to forming the space 625 between the fixed and mobile electrodes of the actuators and possibly a second setback part 1202 that will form the recess 626 that will be located under the mobile part 610. The first setback part 1201 is not as deep as the second setback part 1202. The depth of the first setback part 1201 may be of the order of a few micrometers as was mentioned above, because at least one actuator comprises means forming a pivot.

The means 630 forming a pad type pivot 630.1 may be made by dry etching, for example during etching of the first setback part as illustrated in FIG. 18D. As for the fixed electrodes, the pad is made from the semiconducting material of the second substrate 1200.

The second setback part 1202 is located in a central zone of the first setback part 1201. This etching may be a dry etching. The second substrate 1200 thus etched will materialise the fixed electrodes 620. The fixed electrodes are thus included in the base. The next step is to cover the second substrate 1200 thus etched with a layer of insulating material 1203, for example silicon nitride or an oxide (FIG. 18D). The layer of insulating material 1203 materialises the insulating layer 624 (FIG. 15B) inserted between the fixed electrodes 620 and the mobile electrodes 621, and between the fixed electrodes 620 and the means forming the pivot 630.

The next step is to fix the two substrates 1000, 1200 together by placing the first setback part 1201 facing the etched surface layer 1003 (FIG. 18E).

This fixing may be done by a molecular bonding process after preparing the surfaces to be assembled appropriately. Such a molecular bonding process is known as SDB for Silicon Direct Bonding. The second setback part 1202 faces the first region of the mobile part 610.

For example, coarse mechanical grinding followed by wet etching can be used to remove the base layer 1001 and the lower insulating layer 1002.1 of the sandwich 1002 of the first substrate 1000 (FIG. 18F) from the silicon.

The intermediate layer 1002.3 and the upper insulating layer 1002.2 will then be etched to access the surface layer 1003 so as to delimit contact pads. The zones thus etched are referenced 1008 in FIG. 18G. Interconnection holes 1009 are also etched in the surface layer 1003 and, once metallised, will be used to make contact areas between the mobile electrodes and the parts 1007.1, 1007.1 of the first region of the mobile part 610. These interconnection holes 1009 are excavated in the torsion arms 613 in a zone in which they project from the mobile part 610, but other locations would also be possible. There is the same number of interconnection holes 1009 as mobile electrodes. Contact points will be used to electrically connect the said parts 1007.1, 1007.2 to the mobile electrodes. This etching step is illustrated in FIGS. 18G and 18H.

Metal is then deposited so as to make the contact pads 710 and contact points 711 in the etched zones 1008 and the interconnection holes 1009 (FIG. 18I). The deposited material may be tungsten or aluminium or any other conventionally used metal or alloy.

FIGS. 18J and 18K are sectional and top views respectively showing the result of an etching step in the intermediate layer 1002.3 with the purpose of delimiting the contour of the mobile electrodes 621 with their starters 621.3 and their bodies 621.2, and a second region of the mobile part 610, of a second region of the torsion arms and drive arms (that are coincident). Therefore, the second region of the mobile part, the second region of the torsion arms and the second region of the drive arms are formed in the semiconducting material of the intermediate layer 1002.3.

The first and second regions of the mobile part, the torsion arms and the drive arms are superposed and therefore form a stack of the surface layer 1003, the upper insulating layer 1002.2 and the intermediate layer 1002.3. An insulating trench 712 could be provided between the two mobile electrodes located on each side of the axis 612 and that are fixed to the same torsion arm 613 and an insulating trench 713 between the mobile part 610 and the mobile electrodes 621.

FIG. 18L is a section of the micro-mirror or the micro-lens in a plane AA in FIG. 18J. The contact pads 710 and the contact points 711 that were not in FIG. 18C can be seen.

The reflecting zone 617 of a micro-mirror may be made by the semiconducting material of the intermediate layer 1002.3 located in the second region of the mobile part 610, if it has sufficient reflectivity. It could also be made by metallisation, for example with gold or silver or aluminium or other, of the said second region of the mobile part.

Concerning the manufacture of a micro-lens, a lenticular refracting pellet 617 can be transferred onto the frame forming the mobile part 610, for example by bonding. It is assumed that this pellet is as outlined in FIG. 18K. The zone 617 could also represent the reflecting zone of a micro-mirror.

The terms “left”, “right”, “up”, “down”, “lower”, “upper”, “horizontal”, “vertical” and others are applicable to the embodiments shown or described with reference to the Figures. They are used only for description and are not necessarily applicable to the position occupied by the micro-mirror when it is in operation.

Although several embodiments of micro-mirrors have been described, this invention is not strictly limited to these embodiments. In particular, the number of actuators is not limited to two as illustrated. This number may be arbitrary, there is at least one actuator on one side of the axis and at least one actuator on the other side.

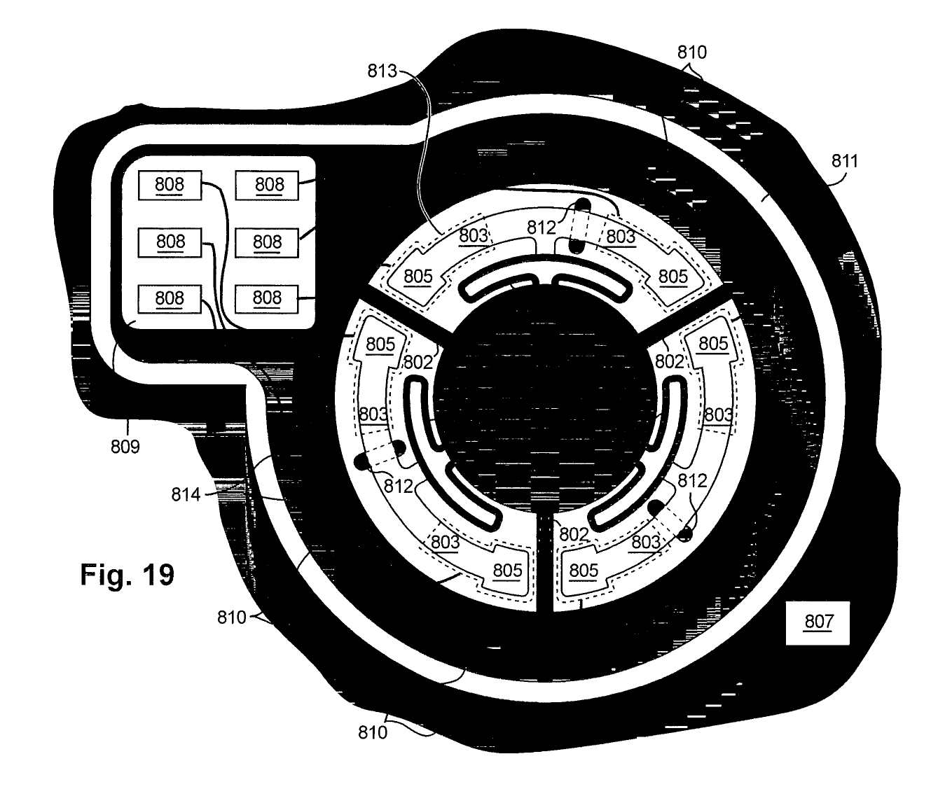

FIG. 19 shows an electrostatic actuator used for displacement in rotation and/or in translation of an object 800 and comprising three or more actuators.

The object 800 may have a closed contour with a curvature. It is shown as being circular in shape in FIG. 19, but other shapes are possible (for example elliptical).

The shape of actuators is then adapted to the shape of the object. For example, they may be in the shape of an arc of a circle, as illustrated in FIG. 19.

This object 800 may an optical component or a support for an optical component, in particular the component may be a mirror for beam aiming applications, or scanning or adaptive optics, or beam shaping, alignment of the mirrors of a laser cavity, or alignment of optical components in general.

For example, two mirrors may be made parallel with the required separating distance using this actuator.

Such a system may be useful for an optical interferometry system, or for a tuneable Fabry-Pérot filter, or for a laser cavity.

But such an actuator system may also be used for alignment of a lens with an optical system, or for centring or adjustment of the distance between these two elements.

Such a system may also be used to adjust the distance between a focusing lens and, for example, an optical storage medium to write or read and/or adjust the focusing point on this medium by rotation of the lens.

In this application, the actuator may also be used to adjust the position of a mirror with respect to the medium.

The actuator may be used to drive a deformable adaptive optic mirror.

It may also be used to make a variable inductance or a variable resistance.

It is shown diagrammatically in FIG. 19 in which reference 800 denotes the moving part; it may be an optical component such as a mirror, for example a 20 μm thick mirror or a support for an optical component.

Arms 802, preferably thin arms, for example 2 μm thick, support the mirror 800 above the cavity during manufacturing.

Actuation means 803 of the type shown in FIGS. 1A, 13A, 14A, are arranged around the part 800 to be moved. FIG. 19 shows 3 actuation devices. Each of them may for example be of the order of 2 μm thick. Reference 812 denotes means forming a pivot, for example a pad, as in the embodiments already presented above.

One or several loops 804 enable radial stretching between the actuation means 803 and the central part 800. For example, a loop with a thickness of about 20 μm. These radial stretching means are optional, and can be used to increase the possibility of displacement of means 800 with respect to the actuation means 803.

Therefore, each stretching loop 804 enables artificial elongation between the means 803 and the central part 800 during displacement. This facilitates large displacements.

Each loop is stiff in vertical bending, due to its high thickness (for example between 10 μm and 20 μm or 40 μm) and it is flexible in lateral bending due to its small width l (for example between 1 and 5 μm) and its large length L (greater than 50 or 100 μm, or between 50 and 200 μm). FIG. 24 shows such a loop 804.

A starter 805 may be used to limit the starting field or voltage for one or several actuation means 803, as already explained above.

The device may also comprise pins 806 located between means 800 and the substrate (therefore not visible in the top view in FIG. 19), in order to prevent bonding of these means 800 on this substrate.

Reference 807 denotes connection pads of actuators (for the mobile electrode or the mobile electrodes).

Reference 808 denotes connection pads of the fixed electrodes arranged in the openings 809 of the contact points.

References 810 denote sealing stops, for example oxide stops, and reference 811 denotes a sealing bead between two rows of stops. This bead 811 may for example be made of a photosensitive polymer.

Fixed electrodes 813 are arranged in the substrate of the device in order to interact with the mobile electrodes 803 as already explained above with reference to FIGS. 1A-15.

Electrical connections tracks 814 connect the fixed electrodes 813 to the pads 808.

In the case of a mirror 800, it is possible to have circular mirrors or other shape mirrors with dimensions of up to a few mm in width, for example with a diameter or width or maximum dimension equal to 10 mm.

The central part of the block 800 can be hollowed out, for example to position a lens in the recess obtained.

The thickness of this part 800 may be between a few μm and a few tens of μm, for example between 5 μm and 30 μm, and also for example of the order of 20 μm, for a diameter for example between 200 μm and 500 μm or 1 mm, which gives a small deformation of the mirror 800 itself during the displacement.

Arms 802 are used for manufacturing the mirror. These arms are sufficiently thin (for example 2 μm thick and 10 μm wide) so that they can be flexible and easily bent. Their length may easily be adapted to not hinder the movement of the mirror 800.

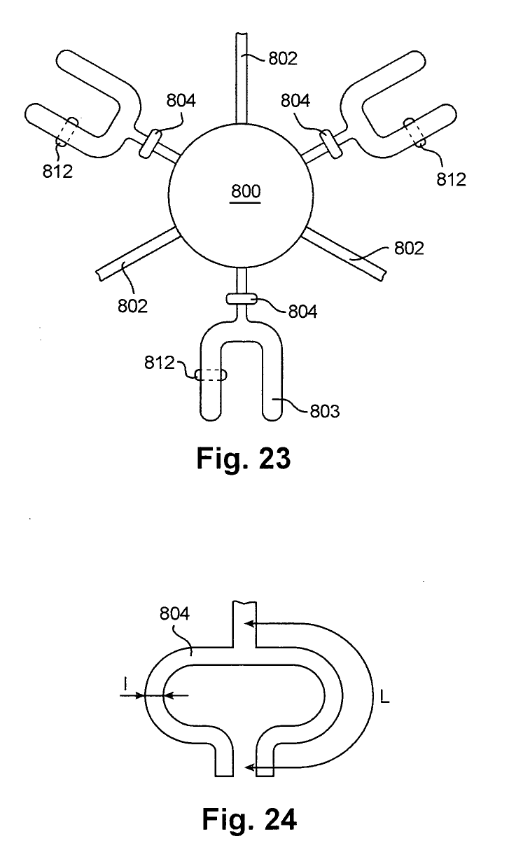

Actuation means 803 may be positioned radially, which facilitates the movement of the mirror but limits the capacitance. Such a variant is illustrated in FIG. 23, on which references identical to those in FIG. 19 denote similar or corresponding elements.

The arms of an actuator 803 are thick, for example between 1 μm and 10 μm thick (for example 3 μm) and their width is between 10 μm and 150 μm or 200 μm, for example. A width of the end part 805 greater than 500 μm enables a small starting voltage.

These arms 803 may be wound or folded to limit their size.

Actuators enable displacement of the means 800 outside the plane defined by their rest position due to an actuation movement as explained above, using both electrostatic attraction forces and mechanical return forces.

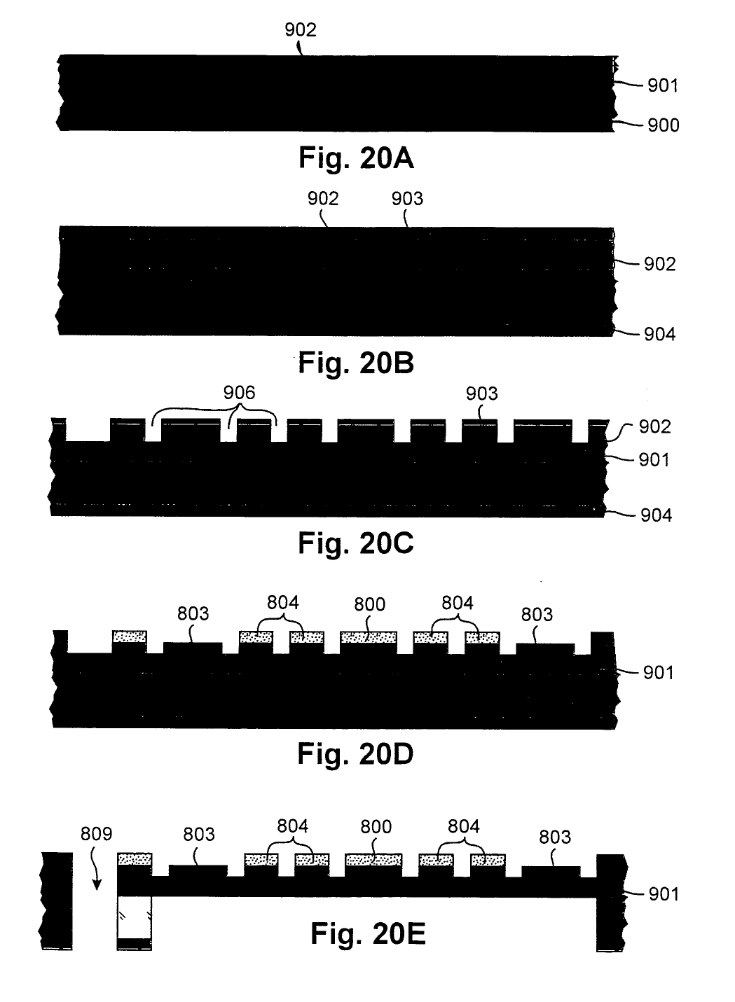

Steps in manufacturing of the mirror and the mobile electrodes in such a device will now be described with reference to FIGS. 20A-20E.

In a first step (FIG. 20A), a semiconducting on insulator type component is selected, for example an SOI type, comprising a substrate 900 made of a first semiconducting material; it may for example be a silicon substrate that may be between 100 μm and 500 μm thick, for example 450 μm. An insulating layer 901, typically made of SiO₂, for example of the order of 10 μm thick, is supported on this substrate 900, this layer 901 itself supporting a layer 902 made of a second semiconducting material, for example also made of silicon, between 1 or 5 micrometers and 10 or 50 micrometers thick, for example of the order of 20 μm.

The next step (FIG. 20B) is a thermal oxidation of this SOI substrate; the result obtained is thus two layers, 903, 904 made of silicon oxide on each side of the substrate.

A layer 905 of a photosensitive resin is deposited on the oxide layer 903 that is itself supported on the layer 902.

The next step (FIG. 20C), is etching of the oxide 903 and partial etching of the silicon layer 902 by lithography using the resin 905, then the formation of patterns 906. These patterns will be used to delimit the central support 800, the electrodes 803 and possibly the stretching means 804.

The next step (FIG. 20D) is to etch the oxide 903 by lithography in zones that will form the actuators 803 and etching of the silicon layer 902, for example to about 18 μm, until the end of etching is detected. Zone 800 is then protected by the oxide 903.

The back face of the substrate (FIG. 20E) can then be etched, the oxide 904 on the back face and the silicon 900 being etched by lithography. Etching may be a KOH or TMAH etching or a deep dry etching.

The final step is etching of the oxide 901. The trench 809 is also obtained by etching.

The mobile part of the device is then ready.

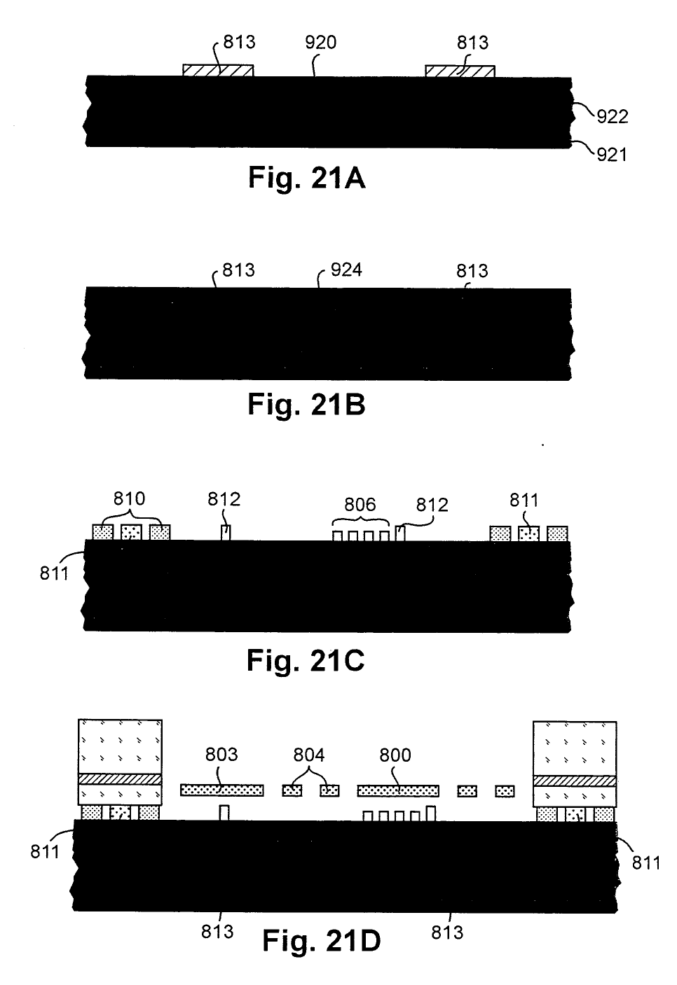

We will now describe manufacturing of the fixed electrodes and stops 806 with reference to FIGS. 21A-21E.

The first step (FIG. 21A) is to form an insulating layer 920, 921, for example by oxidation, on each side of a semiconducting substrate 922, for example silicon, and then a metallic deposit, lithography and etching of the fixed electrodes 813, for example made of aluminium.

An oxide layer 924 is deposited on the face of the substrate on which the electrodes 813 were made, for example using the PECVD technique (FIG. 21B), this layer is then planarised.

The next step (FIG. 21C), is to form the sealing stops 810, pads 812 and anti-bonding pads 806 by deposition. This is followed by etching.

A sealing bead 811 may then be made by lithography of a photosensitive polymer layer deposited between the stops 810.

The next step (FIG. 21D) is to assemble the two substrates (that in FIG. 20E and that in FIG. 21C), by sealing using the sealing bead 811. For reasons of clarity, FIG. 21D does not show all elements of the mobile part; in particular, only one bead 804 and only one actuator 803 are shown.

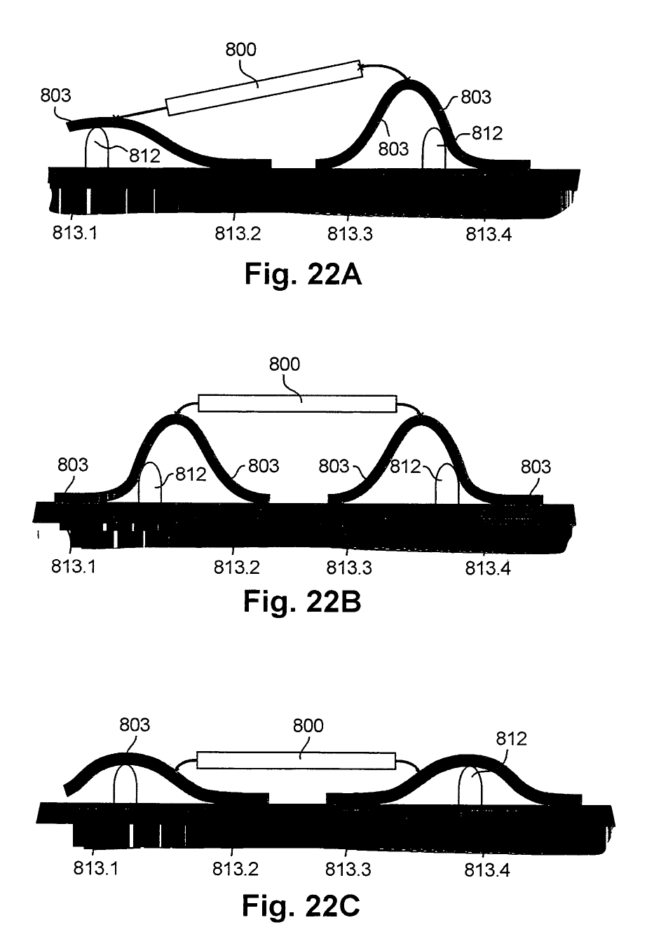

FIGS. 22A-22C illustrate a diagrammatic operation of the device that has just been described.

In FIG. 22A, the fixed electrodes 813-2 and 813-4 are electrodes to which the highest voltages are assigned, while electrodes 813-1 and 813-3 are assigned lower voltages. The result is a movement of the flexible membranes and inclination of the mirror or the optical component or the support 800, as indicated in FIG. 22A.

The component or the support 800 may be returned to the high position as illustrated in FIG. 22B, by assigning the highest voltages to the fixed electrodes 813-1 and 813-4, while the electrodes 813-2 and 813-3 are assigned the lower voltages. The two flexible membranes 803 and the component 800 are then in the high position.

A low position may be reached (FIG. 22C) by assigning the highest voltages to the electrodes 813-2 and 813-3, while the lowest voltages are assigned to the other electrodes.

### BIBLIOGRAPHIC REFERENCES

[1]: “A Novel Electrostatic Actuator for Micro Deformable Mirrors: Fabrication and Test”, C. Divoux, J. Charton, W. Schwartz, E. Stadler, J. Margail, L. Jocou, T. Enot, J. C. Barbe, J. Chiaroni and P. Berruyer, Transducers '03, IEEE, 12th International Conference on Solide-State Sensors, Actuators and Microsystems, Boston, Mass., USA, Jun. 8-12, 2003.
[2] “Electrostatically Excited Diaphragm driven as a Loudspeaker”, P. Rangsten, L. Smith, L. Rosengren, B. Hök, Transducers 95, the 8th International Conference on Solid State Sensors and Actuators, and Eurosensors IX, Stockholm, Sweden, Jun. 25-29, 1995.
[3]: “Electrostatic Curved Electrode”, Rob Legtenberg, John Gilbert, Stephen D. Senturia, Miko Elwenspoeck, Journal of Microelectromechanical System, vol. 6, no 3, September 1997.
[4]: “A new Electrostatic Actuator providing improved Stroke Length and Force”, Jeans Branebjerg, Perter Gravesen, Micro Electro Mechanical Systems '92, Travemunde (Germany), Feb. 4-7, 1992.

1-62. (canceled)

63. An electrostatic actuation device comprising:
at least one mobile electrode, comprising at least one part free to move with respect to a substrate;
at least two electrodes, fixed with respect to the substrate, located on a same side as the mobile electrode and each facing a part of the mobile electrode; and
means for forming at least one pivot of at least one portion of the mobile electrode, wherein the mobile electrode may bear on the pivot when one of the fixed electrodes attracts the part of the mobile electrode facing the fixed electrode, the other part of the mobile electrode possibly moving away from the substrate by mechanical return forces.

64. A device according to claim 63, the mobile electrode comprising at least one mobile part along at least one direction perpendicular to the substrate.

65. A device according to claim 63, the two fixed electrodes being separated from the mobile electrode by an insulating layer formed on the substrate and/or the mobile electrode.

66. A device according to claim 63, the mobile part of the mobile electrode being connected by a pad to a membrane.

67. A device according to claim 63, the means for forming the pivot comprising at least one pad fixed with respect to the substrate.

68. A device according to claim 63, the means for forming the pivot comprising at least one arm arranged laterally with respect to the mobile part, or two arms arranged on each side of the mobile part.

69. A device according to claim 63, the mobile part of the mobile electrode forming an elbow.

70. A device according to claim 63, comprising four fixed electrodes arranged in pairs facing each other, the mobile electrode comprising two mobile parts arranged crosswise.

71. A device according to claim 70, comprising two pivots.

72. A device according to claim 65, the mobile electrode comprising at least one part embedded or fixed on or in the substrate or the insulating layer.

73. A device according to claim 63, each fixed electrode being located facing at least one end of the mobile electrode, on one side of the means for forming the pivot.

74. A device according to claim 63, the mobile electrode comprising at least two mobile parts, each part being free at one of its ends, a fixed electrode located facing each mobile part.

75. A device according to claim 74, the mobile electrode comprising three mobile parts, there being three fixed electrodes, each located facing a part of the mobile electrode.

76. A device according to claim 74, each mobile part of the mobile electrode being approximately elongated, and being laterally or angularly offset from each other.

77. A device according to claim 63, comprising three fixed electrodes, the mobile part comprising three strips connected through an end.

78. An electrostatic actuation device comprising:
a mobile part or flexible membrane being mobile or flexible, with respect to a substrate, the part or membrane comprising at least two electrodes, separated by an electrically insulating portion;
at least one electrode, fixed with respect to the substrate, located on a same side of the mobile part or flexible membrane and for which a first part and a second part are located facing one of the corresponding electrodes of the mobile part or flexible membrane; and
means for forming at least one pivot of at least one portion of the mobile part or flexible membrane that may bear on the pivot when one of the fixed electrodes attracts one of the electrodes of the mobile part or flexible membrane, the other mobile electrode being free to move away from the substrate by mechanical return forces.

79. A device according to claim 78, the mobile part or flexible membrane being free to move along at least a direction perpendicular to the substrate.

80. A device according to claim 78, the two fixed electrodes being separated from the mobile electrode by an insulating layer formed on the substrate and/or the mobile electrode.

81. A device according to claim 78, the mobile part or flexible membrane being connected by a pad to a membrane.

82. A device according to claim 78, the means forming the pivot comprising at least one pad fixed with respect to the substrate.

83. A device according to claim 78, the means for forming the pivot comprising at least one arm arranged laterally with respect to the mobile part or flexible membrane, or two arms arranged on each side of the mobile part or flexible membrane.

84. A device according to claim 78, the mobile part or flexible membrane forming an elbow.

85. A device according to claim 78, comprising four fixed electrodes arranged in pairs facing each other, the mobile part or flexible membrane comprising two mobile parts or two flexible membranes arranged crosswise.

86. A device according to claim 85, comprising two pivots.

87. A device according to claim 80, the mobile part or flexible membrane comprising at least one part embedded or fixed on or in the substrate or the insulating layer.

88. A device according to claim 78, each fixed electrode being located facing at least one end of a mobile electrode, on one side of the means for forming the pivot.

89. A device according to claim 78, the mobile part or flexible membrane comprising at least two mobile electrodes or two flexible membranes, connected at one end by an insulating portion, each mobile electrode being free at one of its ends, a fixed electrode facing each mobile electrode.

90. A device according to claim 89, the mobile part or flexible membrane comprising three mobile electrodes.

91. A device according to claim 89, the mobile electrodes being approximately elongated and being laterally or angularly offset from each other.

92. A device according to claim 78, comprising at least two fixed electrodes.

93. A device according to claim 63, an electrical contact element being fixed on the mobile part.

94. A device according to claim 63, the mobile electrode, the fixed electrodes, and the pivot being approximately in a plane on a surface of the substrate.

95. A device according to claim 63, at least one mobile electrode comprising magnetic or partially magnetic means, the device further comprising fixed magnetic means with respect to the substrate, for creating a contact with the magnetic means of the mobile electrode.

96. A device according to claim 95, an electrostatic force and magnetic force involved during a contact having a relative difference of about 10%.

97. A device according to claim 95, an electrostatic force and magnetic force involved during a contact being greater than the mechanical return forces.

98. A device according to claim 97, an electrostatic force and magnetic forces involved during a contact being at least 10 times greater than the mechanical return forces.

99. A device according to claim 95, the magnetic means of the mobile electrode and the fixed magnetic means defining at least two stable positions of the device.

100. A device according to claim 63, further comprising at least one fixed electrode and one mobile electrode defining a capacitor.

101. A device according to claim 63, the means for forming the pivot being used to hold a point of a mobile electrode at a height of between 50 nm and 20 cm with respect to the substrate.

102. An actuation device for an optical component comprising:
at least one electrostatic actuation device according to claim 63;
support means for an optical component, connected to the mobile electrode, and being driven in displacement by the mobile electrode during displacement of the mobile electrode.

103. A device according to claim 102, at least one of the electrodes of one of the actuation devices comprising an elongated body with a first width along a first direction and a starter end with a second width wider than the first width.

104. A device according to claim 102, comprising two electrostatic actuation devices, the support means of an optical component being connected to the two devices.

105. A device according to claim 104, the two actuation devices being arranged on each side of the support means of an optical component.

106. A device according to claim 104, the two actuation devices being arranged on a same side as the support means of an optical component.

107. A device according to claim 104, the two actuation devices extending along two directions approximately parallel to each other.

108. A device according to claim 104, the two actuation devices each comprising a curved part.

109. A device according to claim 108, the two actuation devices being mechanically connected by at least one common end.

110. A device according to claim 104, comprising two drive arms connecting the two electrostatic actuation devices to the support means of an optical component.

111. A device according to claim 104, comprising a substrate in which a cavity enables pivoting of support means of the optical component.

112. A device according to claim 104, further comprising a frame and connecting means connecting the electrostatic actuation device and the support means of an optical component to the frame.

113. A device according to claim 112, the connecting means comprising torsion arms.

114. A device according to claim 104, the support means having a closed contour with a curvature.

115. A device according to claim 114, the electrostatic actuation means being arranged around or along the contour.

116. A device according to claim 114, the electrostatic actuation means being arranged radially with respect to the contour.

117. A device according to claim 114, the contour being circular.

118. A device according to claim 114, further comprising stretching means arranged between the electrostatic actuation means and the support means.

119. A device according to claim 118, the stretching means comprising at least one stretching loop.

120. A manufacturing process for a device according to claim 63, comprising:
creating a first substrate, comprising one or two fixed electrodes with respect to the substrate;
forming the pivot and a mobile electrode or membrane, comprising at least two electrodes separated by an insulating portion, the electrode or membrane being free to move with respect to the first substrate.

121. A process according to claim 120, the mobile electrode or membrane being made on a sacrificial layer formed or deposited on the first substrate, and then eliminated after formation of the mobile membrane or electrode.

122. A process according to claim 122, the mobile electrode or membrane being made on the surface of a second substrate then assembled with the first substrate.

123. A process according to claim 121, the mobile electrode or membrane then being removed from the surface of the second substrate by thinning the second substrate.

124. A process according to claim 120, the means for forming the pivot being formed on the first substrate.
